(19) United States
(12) Patent Application Publication
(10) Pub. No.: US 2023/0165280 A1
(43) Pub. Date: Jun. 1, 2023

(54) DEGUTTED INSECT WITH IMPROVED NUTRITIONAL QUALITY AND MICROBIAL QUALITY, PROCESSED INSECT PRODUCT WITH IMPROVED NUTRITIONAL QUALITY, IMPROVED COLOR, AND IMPROVED MICROBIAL QUALITY, METHOD FOR OBTAINING SAID DEGUTTED INSECT

(71) Applicant: Protix B.V., Dongen (NL)

(72) Inventors: Eric Holland Schmitt, Dongen (NL); Seyed Ali Hosseini, Dongen (NL); Aman Paul, Dongen (NL)

(73) Assignee: Protix B.V., Dongen (NL)

(21) Appl. No.: 17/798,581

(22) PCT Filed: Feb. 15, 2021
(86) PCT No.: PCT/NL2021/050099

§ 371 Date: Aug. 10, 2022

(30) Foreign Application Priority Data
Feb. 17, 2020 (NL) 2024929

(51) Int. Cl. A23K 40/00; A23K 10/20; A23J 1/00; A23K 10/26; A23K 20/10; A23K 30/20; A23K 40/10; A23K 50/48; A23K 50/75; A23L 13/00; A23L 35/00; A23L 5/20

(52) U.S. Cl. CPC A23K 40/00; A23J 1/00; A23K 10/20; A23K 10/26; A23K 20/10; A23K 30/20; A23K 40/10; A23K 50/48; A23K 50/75; A23L 5/23; A23L 13/00; A23L 35/00; A23V 2250/51; A23V 2250/204; A23V 2250/542; A23V 2300/50

(57) ABSTRACT

The invention relates to a method for the provision of degutted insects, such as black soldier fly larvae and mealworm, preferably live degutted insects. The invention also relates to degutted (live or dead) insects such as larvae and to processed degutted insects such as larvae. The invention also relates to the use of the degutted insect according to the invention or use of the processed degutted insect of the invention for the separation of the degutted insect or of the processed degutted insect in at least a fat fraction and/or at least a protein fraction. In addition, the invention relates to an insect product, wherein the insect product is any one of live or dead insect, insect puree, minced insect, insect powder, particulate insect, granulated insect, or insect meal, dried insect, oven-dried insect, lyophilized insect, or oven-dried insect using refractive drying obtained from degutted insect provided with the method of the invention. The invention also relates to an insect product, wherein the insect product is insect gut content, wherein the gut content is provided with the method of the invention. Finally, the invention relates to the method, the degutted insect provided with the method, the degutted insect, insects products, insect gut content according to the invention, wherein the insect is black soldier fly, preferably black soldier fly larvae, or wherein the insect is mealworm.

### TECHNICAL FIELD

The invention relates to a method for the provision of degutted insects, such as degutted living insect larvae or dead insects. The invention also relates to degutted insects, such as degutted living insect larvae or dead insects, and to processed degutted insect larvae. Furthermore, the invention relates to the use of the degutted insect of the invention for the provision of processed degutted insect. The invention also relates to the use of the (live or dead) degutted insect according to the invention or use of the processed degutted insect of the invention for the separation of the degutted insect or of the processed degutted insect in at least a fat fraction and/or at least a protein fraction. In addition, the invention relates to an insect product, wherein the insect product is any one of insect powder, particulate insect, granulated insect, or insect meal, dried insect, oven-dried insect, lyophilized insect, or oven-dried insect using refractive drying, or minced insects such as, for example, insect puree, obtained from degutted insect provided with the method of the invention. The invention also relates to an insect product, wherein the insect product is insect gut content, wherein the gut content is provided with the method of the invention. Finally, the invention relates to the method, the degutted insect provided with the method, the degutted insect, insects products, insect gut content according to the invention, wherein the insect is black soldier fly, preferably black soldier fly larvae, or wherein the insect is mealworm.

### BACKGROUND ART

Insects are considered one of the most promising sources for fulfilling current and future demand for nutrients, e.g., protein and fat. Prominent examples of species proposed for the indicated applications include the black soldier fly (Hermetia illucens), the house fly (Musca domestica), and the mealworm (Tenebrio molitor L.).

Methods for improving the efficiency of insect farming relating to improvements in insect processing and insect product production are particularly valuable for large scale production. This, because of the batch wise nature of the insect farming steps that should be performed and cannot be avoided while working with livestock, in orderto be able to arrive at an economically viable scale. Despite the batch wise farming, or rearing of insects, for example, insect processing into products desirably is a continuous process. In a continuous process, a manufactory for producing insect-based products is used efficiently, and no production capacity and production time is lost. Therefore, continuous use and processing of insects should preferentially not be hampered by batch-to-batch supply of ready-to-process insects. Since large-scale insect farming and subsequent insect processing into products is a desired industrial activity that involves live animals, a method and means for a continuous supply of insects would contribute to efficient use of farming facilities and insect processing facilities, and would aid in achieving predictable and controllable production volumes.

Thus, to the benefit of industrial-scale insect farming and subsequent industrial-scale insect processing and insect-based product manufacturing, efficaciously, timely and beneficially supplying (food-grade) insects in a continuous manner despite the batch-wise culturing (rearing) steps and pre-processing steps involved in rearing insects, is an important requirement. One of the most important aspects that influences the economic success of large-scale industrial insect farming and product manufacturing therewith is the required time for processing mature ready-to-process insects such as larvae into valuable products. Importantly, preparing and sufficiently cleaning insects as part of the pre-processing steps, may take over 12 hours up to days, which severely hampers fast turn-over time from living insects into end-products. Cleaning insects before processing the insects into end-products increases product safety and relates to lowering of the microbial load of pre-processed insects and of the final end-products. However, methods and means to the benefit of said purposes of speeding up insect processing are at present not available in the art.

Therefore, a solution still needs to be found that allows for feasible means for providing an uninterrupted supply of insects including a fast and easy-to-apply insect pre-processing cleaning method at economically sufficient large scale when industrial insect farming and industrial insect-based product production is considered.

### SUMMARY

The inventors realized that shortening the pre-slaughter period for insects is important to avoid the decline of nutritional and microbial qualities of insects such as larvae. It is a first goal of an embodiment of the present invention to provide an improved batch of insects when nutritional qualities and/or microbial qualities are concerned.

It is therefore in an embodiment one of the objectives of the current invention to provide a (more) cost-effective and/or fast or faster and/or easy-to-apply or easier-to-apply method for providing improved insects when the time window between harvesting of insects and processing of insects is concerned and/or when the nutritional value of the insects is concerned and/or when the microbial load of (processed) insects is concerned.

In an embodiment, at least one of the above objectives is achieved by providing a method for pre-processing insects between harvesting insects from a feed substrate and slaughtering / processing of the insects, of the invention.

An aspect of the invention relates to a method for providing a degutted insect, the method consisting of the steps or the method comprising the steps:
a. providing an insect and providing a liquid at a predetermined temperature;
b. suspending the insect of step a. in the liquid of step a. and incubating the insect in the liquid for a predetermined time at the predetermined temperature or at a temperature range, therewith stimulating degutting of the insect and release of gut content of the insect into the liquid; and
c. at the end of the predetermined time of step b., optionally separating the insect of step b. from the liquid comprising gut content,
therewith providing the degutted insect by step b. or by optional step c. and providing liquid comprising gut content.

Preferred is the method according to the invention, wherein the insect is black soldier fly, preferably black soldier fly larvae, more preferably, black soldier fly larvae 5 to 25 days of age, preferably 10-20 days post-hatching, most preferably black soldier fly larvae at a stage 6 hours – 4 days before prepupation of the larvae, such as 6 hours – 30 hours before prepupation of the larvae, or wherein the insect is mealworm. Preferably, the insect is larvae of BSF. Also preferred is the method according to the invention, wherein in step b. and in optional step c. the provided degutted insect is a live degutted insect, preferably a live black soldier fly larva or a live mealworm.

Preferred is the method for providing a degutted insect according to the invention, wherein the method consists of the steps of or wherein the method comprises the steps of:
a. providing an insect and providing a liquid at a predetermined temperature;
b. suspending the insect of step a. in the liquid of step a. and incubating the insect in the liquid for between 5 minutes and 96 hours at a temperature of above 12° C. and below 37° C. or at a temperature range between from minimally 12° C. at the start of the incubation and maximally 37° C. at the end of said incubation or at a temperature range between from maximally 37° C. at the start of the incubation and above 12° C. at the end of said incubation, therewith stimulating degutting of the insect and release of gut content of the insect into the liquid; and
c. at the end of the predetermined time of step b., optionally separating the insect of step b. from the liquid comprising gut content,
therewith providing the degutted insect by step b. or by optional step c. and providing liquid comprising gut content.

Optionally, in the method according to the invention, the predetermined temperature in step b. is 15° C. – 33° C., preferably 18° C. – 30° C., more preferably 20° C. – 28° C., such as 21° C. – 27° C. or 22° C. or 26° C., or wherein the temperature range in step b. is a temperature range from 15° C. to 33° C. or from 33° C. to 15° C., more preferably from 18° C. to 30° C. or from 30° C. to 18° C., most preferably from 20° C. to 28° C. or from 28° C. to 20° C., such as from 21° C. to 27° C. or from 27° C. to 21° C.

Optionally, in the method according to the invention, the predetermined time is between 10 minutes – 48 hours, preferably 20 minutes – 24 hours, more preferably 30 minutes – 12 hours, such as 45 minutes, 1 hour, 1.5 hour.

An aspect of the invention relates to degutted insect wherein the gut of the insect is at least partly filled with liquid. The insect is preferably black soldier fly larvae or mealworms. The liquid is preferably water. Typically, the degutted insect is provided with the method of the invention. Therefore, preferred is a degutted insect wherein the gut of the insect is at least partly filled with liquid, wherein the degutted insect is obtained with the method of the invention, or wherein the degutted insect is obtainable by the method of the invention. Preferred is the degutted insect wherein the gut of the insect is at least partly filled with liquid, wherein preferably the degutted insect is a living black soldier fly larva, preferably 10 –14 days of age post hatching, wherein the liquid preferably is water such as tap water, and wherein preferably the degutted insect has taken in feed up to a time point 30 minutes – 3 hours in the past. That is to say, to their surprise, the inventors provide a living BSF larvae, e.g., 10 –14 days of age post hatching, that has taken in feed up to a short period of time, e.g., 30 minutes – 3 hours of time, before the degutted insect is provided, while still a substantial amount of the gut content of the insect has been replaced with water, while the insect is still alive and did essentially not lose weight due to starvation. To the knowledge of the inventors, they are the first who provide living larvae that are degutted for at least 50%, wherein the gut is filled with water, while the time from the last feeding of the larvae up to the provision of degutted larvae is as short as 30 minutes, 1 hr, 2 hr, 3 hr, etc. such as 20 minutes – 4 hr, 90 minutes – 2.5 hr, therewith preventing loss of valuable insect protein and insect fat due to starvation of the insect, which occurs with methods known in the art (e.g. starvation for 1–3 days). Keeping insects alive while degutting improves the quality of the processed insects afterwards, since microbial burden is lower than when insects would die during degutting processing and/orwhen starving during degutting. In the process of the invention, degutting is a fast process (e.g., 30 minutes – 90 minutes), insects stay alive, and microbial burden decreases due to expelling gut content from the larvae.

Also preferred is the method according to the invention, wherein in step b. and in optional step c. the provided degutted insect is a live degutted insect, preferably a live black soldier fly larva or a live mealworm.

An aspect of the invention relates to the use of the (live or dead or a mixture of live and dead) degutted insect according to the invention for the provision of processed degutted insect, the processing comprising, for example, any one or more of mincing, cutting, particulating, pressing, grinding, crunching, drying, heating, blanching, lyophilizing, fractioning, hydrolyzing degutted insect, and any combination thereof. Mincing is preferred, for example, with degutted black soldier fly larvae, therewith providing degutted black soldier fly (BSF) larvae puree.

An aspect of the invention relates to the use of the (live or dead) degutted insect according to the invention or to the use of the processed degutted insect of the invention for the separation of the degutted insect or of the processed degutted insect in at least a fat fraction and/or at least a protein fraction, preferably in both a fat fraction and a protein fraction, wherein preferably the fat fraction comprises at least 35% by weight insect fat based on the total dry weight of the degutted insect or the processed degutted insect, more preferably at least 38%, such as 38% – 42%, and/or wherein preferably the protein fraction comprises at least 40% by weight insect protein based on the total dry weight of the degutted insect or the processed degutted insect, more preferably at least 45%, such as 44% – 50%.

An aspect of the invention relates to an insect product, wherein the insect product is degutted live or dead insect, wherein the degutted insect is preferably provided with the method of the invention or obtained from the degutted insect of the invention.

An aspect of the invention relates to an insect product, wherein the insect product is insect puree obtained from degutted insect, wherein the degutted insect is preferably provided with the method of the invention or obtained from the degutted insect of the invention or obtained from the processed degutted insect of the invention.

An aspect of the invention relates to an insect product, wherein the insect product is insect powder, particulate insect, granulated insect, or insect meal, obtained from degutted insect, wherein the degutted insect is preferably provided with the method of the invention or obtained from the degutted insect of the invention or obtained from the processed degutted insect of the invention.

An aspect of the invention relates to an insect product, wherein the insect product is dried insect, oven-dried insect, lyophilized insect, or oven-dried insect using refractive drying, obtained from degutted insect, wherein the degutted insect is preferably provided with the method of the invention or obtained from the degutted insect of the invention or obtained from the processed degutted insect of the invention.

An aspect of the invention relates to an insect product, wherein the insect product is insect gut content, wherein the gut content is preferably provided with the method of the invention.

Preferred is the insect product according to the invention, wherein the insect is black soldier fly (Hermetia illucens), preferably black soldier fly (Hermetia illucens) larvae, or wherein the insect is mealworm. An embodiment is the insect product according to the invention, wherein the insect larvae of the black soldier fly (Hermetia illucens), or wherein the insect is mealworm.

The embodiments of the invention described herein can operate in combination and cooperation, unless specified otherwise.

### DEFINITIONS

The term “gut evacuation” has its regular scientific meaning throughout the text, the same as the term “degutting”, and here refers to the stimulated expelling of the content of the gut of an insect such as larvae or mealworms.

The term “prepupae”, or “prepupa”, has its regular scientific meaning throughout the description, drawings, claims, etc., and here refers to the developmental stage of a metamorphic insect prior to entering the pupal stage.

The term “prepupation” has its regular scientific meaning throughout the description, drawings, claims, etc., and here refers to the developing of an insect larva of a metamorphic insect into a prepupa.

### BRIEF DESCRIPTION OF THE DRAWINGS

FIG. 1. Percentage of gut evacuation over time in black soldier fly larvae reared on two different diets (feed) and kept under different temperature- and substrate conditions after harvest. ‘R4B’ = regular BSF larvae feed consisting of grain meal and potato meal in water. ‘trt’: treatment.

FIG. 2. Wet and dry weight of black soldier fly larvae stimulated and unstimulated for gut evacuation.

FIG. 3. Percentage of crude fibre, ash, fat and protein in the dry matter of black soldier fly larvae that were either stimulated to evacuate their gut, or were not stimulated to evacuate their gut.

FIG. 4. Color of the puree prepared from the whole stimulated BSF larvae or the whole unstimulated BSF larvae, which batches of puree were kept at room temperature for 2 hours.

FIG. 5. Total microbial plate count in the pasteurized puree consisting of minced BSF larvae that were stimulated for gut evacuation prior to the processing into puree, and minced BSF larvae that were not stimulated for gut evacuation prior to the processing into puree.

FIG. 6. Gut evacuation in mealworm over time, at day 1, 2 and 3. n = number of mealworm larvae dissected for analysis of the gut content. Error bars show the standard errors of the mean.

FIG. 7. Percentage of gut evacuation in mealworm on different indicated days 1, 2 and 3, and at day 1 in the mealworms stimulated to evacuate their gut by incubating the mealworms for 1 h in water at room temperature. n = number of mealworm larvae dissected. Error bars show the standard errors of the mean.

### DETAILED DESCRIPTION

The gastrointestinal tract of animals is rich in microbes and various digestive enzymes, and it has a pH that is different from the pH in the rest of body (Bonelli et al., 2019). In food/feed species, the quality of the edible parts will be negatively affected if they are mixed with the gut content and/or if they are exposed to the gut content. In large animals such as broiler chicken or pig the whole gut is removed during slaughtering. In small animals such as shrimps, snails, mealworms, and Black Soldier Fly (BSF) it is not feasible to remove the gut. In these species a pre-slaughter fasting step is currently used. For the BSF larvae, it had been established that fasting for as long as up to 3 days is required in order to achieve sufficient extent of degutting. A problem that is encountered with fasting of the insects for e.g. 3 days is the weight loss of the insects after fasting compared to the weight of the insects before fasting started. It has also been shown that degutting by fasting not only did not improve the microbial quality of the larvae but also reduced their nutritional quality because the larvae metabolized nutrients they had built up during previous feeding. A further problem encountered when insects such as BSF larvae are subjected to fasting is that at least a fraction of the larvae start pupating when the larvae are subjected to (prolonged) duration of fasting. Prepupated and pupated insects are not suitable anymore for various processing steps conducted with larvae before the prepupation phase (e.g. extraction of oil, proteins).

The current inventors now provide a method for relatively rapid degutting of insects, such as BSF larvae and mealworms (in less than 3 days, such as in the order of hours to 1 or 2 days, such as within 1-2 hours, e.g. in 1 hour). This method is solving the problem of the current long the pre-slaughter period relating to the fasting period, which extended fasting period correlates with increasingly decline of microbial and nutritional quality of larvae over time and, when, for example, BSF larvae are considered, correlates with relatively higher percentage of the larvae turning into black prepupae (which are less useful for producing processed insects since products derived from a batch of insects that comprises to a certain extent such black prepupae, have a less appealing and more dark color and appearance, compared to products derived from insects batches that do not comprise prepupae). The current inventors, to the best of their knowledge, are the first to assess the extent of insect degutting (gut evacuation) over time through dissection of the larvae and microscopic assessment of the gut content before and after fasting compared to gut content of insects obtained with the degutting method of the current invention. The inventors now provide improved and optimal environmental conditions for a relatively quick degutting step after harvesting of insects and before slaughtering of the insects, reducing the degutting time from 3 days to 2 days or less, such as 1 h. The inventors also provide a method for degutting insects at the pre-slaughtering stage, which results in decreased microbial burden post-slaughtering when compared to the microbial count determined for insects that were subjected to a degutting step involving fasting according to current practice, improved color (less dark products obtained from slaughtered insects, when compared to products obtained from insects that were subjected to a fasting period prior to slaughter), and improved nutritional quality of the insects (increased relative content of fats and/or increased relative content of proteins, compared to nutritional quality of insects obtained after a period of fasting prior to slaughter), such as BSF larvae or mealworms.

An embodiment is the method of the invention for the provision of degutted insect, wherein the degutted insect has an improved taste compared to the taste of the insect provided in step a. of the method before being subjected to step b. and optionally step c. In evolutionary biology, without wishing to be bound by any theory, a good taste typically means the food is safe and beneficial to eat, so it will be eaten faster and more than a bad taste food, for example by human subjects, chicken, mammals. For the insects subjected to the method of the invention, such as mealworm and BSF, in particular the BSF larvae, less gut materials after degutting (thus, presence of e.g. less intestinal juice and organic waste in the insect compared to the non-degutted insect of step a. of the method) will improve the taste of the insects such as BSF larvae and mealworm, as they become more beneficial in terms of nutrients and safer in terms of microbes and unwanted enzymes.

The present invention will be described with respect to particular embodiments but the invention is not limited thereto but only by the claims.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

The embodiments of the invention described herein can operate in combination and cooperation, unless specified otherwise.

Furthermore, the various embodiments, although referred to as “preferred” or “e.g.” or “for example” or “in particular” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a method comprising steps A and B” should not be limited to the method consisting only of steps A and B, rather with respect to the present invention, the only enumerated steps of the method are A and B, and further the claim should be interpreted as including equivalents of those method steps. Thus, the scope of the expression “a composition comprising A and B” should not be limited to the composition consisting only of compounds A and B, rather with respect to the present invention, the only enumerated compounds of the composition are A and B, and further the claim should be interpreted as including equivalents of those compounds.

In addition, reference to an element by the indefinite article “a” or “an” does not exclude the possibility that more than one of the element are present, unless the context clearly requires that there is one and only one of the elements. The indefinite article “a” or “an” thus usually means “at least one”.

An aspect of the invention relates to a method for providing a degutted insect, the method consisting of the steps or the method comprising the steps:
a. providing an insect and providing a liquid at a predetermined temperature;
b. suspending the insect of step a. in the liquid of step a. and incubating the insect in the liquid for a predetermined time at the predetermined temperature or at a temperature range, therewith stimulating degutting of the insect and release of gut content of the insect into the liquid; and
c. at the end of the predetermined time of step b., optionally separating the insect of step b. from the liquid comprising gut content,
therewith providing the degutted insect by step b. or by optional step c. and providing liquid comprising gut content.

Preferred is the method according to the invention, wherein in step b. and in optional step c. the provided degutted insect is a live degutted insect, preferably a live black soldier fly larva or a live mealworm. Preferably, step c. of the method is performed, providing degutted insects such as BSF larvae free of liquid comprising the expelled gut content, and preferably the liquid is water.

The step b. essentially consists of pouring the liquid such as water or a physiological buffer solution into a container which contains the insects, or transferring the provided insects into the liquid, such as water. The ratio between the weight of the insects provided in step a. of the method and the weight or the volume of the liquid is, for example, between 1:1 and 1:1000 when the amount of insects and the amount of liquid is considered, respectively. Further examples of the ratio between the weight of the insects, such as larvae of BSF or mealworms, provided in step a. of the method and the weight or the volume of the liquid is, for example, between 1:2 and 1:500, such as 1:10, 1:25, 1:50, 1:100, 1:250. For example, 1 kg of insects is suspended in 20 liter of liquid such as water, or to 10 kg of insects 100 liter of liquid is added. Preferably, the amount of liquid is selected such that in step b. suspended insects are provided wherein the suspended insects are freely floating in the liquid under gently stirring or agitation or tumbling of the (closed) container comprising the suspended insects of step b. of the method. ‘Freely floating’ of the insects has to be understood as a batch of suspended insects which does not comprise a (densely) packed cluster of insects, for example, on the bottom of the container, with no or hardly any liquid surrounding the insects and with insects contacting each other. To the contrary, ‘freely floating’ insects has to be understood in the context of the method as insects that are fully surrounded by liquid during step b. of the method. The incubation of the suspended insects in step b. of the method is understood as a batch of suspended insects in the liquid that is left still for the predetermined time period, or that is at least during part of the time period, for example, rocked, shaken, stirred, agitated, tumbled, etc., such that the suspended insects are periodically or constantly moved and mixed with the liquid surrounding the insects, such that, for example, a flow of liquid is locally created around the bodies of the insects.

The inventors established, to their surprise, that keeping insects suspended in a liquid such as water for a predetermined time, wherein the liquid was at a predetermined temperature, was efficacious and sufficient for stimulating the degutting of the insects to a certain extent. Herewith, an alternative and fast method is provided for providing degutted insects, compared to the standard of fasting insects for over 2 days. The method of the invention requires limited steps and limited equipment and materials. Mixing insects and liquid such as water in a container, controlling incubation time for the suspended insects and controlling temperature of the suspended insects suffices for obtaining degutted insects. Extend of degutting using the method of the invention is similar or better than the extend of degutting achievable by 3 days fasting of insects such as BSF larvae or mealworms. Degutting efficiency of at least 50%, such as at least 60%, at least 70%, at least 80% and even at least 90%, is achieved with the method of the invention. Degutting efficiency is to be understood as the rate of established degutting upon subjecting insects to the method of the invention. Thus, a degutting rate of, for example, 50% refers to insects which have at the end of step b. of the method of the invention 50% less gut content in their guts compared to the amount of gut content at step a. of the method, before being subjected to the method. Fifty percent of the gut content is evacuated at the end of step b. or c., in this example. These degutting efficiencies are not or hardly achievable when applying current degutting methods such as 3 days fasting. Moreover, the predetermined incubation time of step b. of the method is shorter than 3 days, for achieving the improved extent of degutting. For the purpose of keeping insects alive during and after the degutting process of the invention, optionally step c. of the method of the invention is applied. Discarding the liquid comprising the gut content from the degutted insects is applied using common techniques known to the skilled person. For example, the liquid is poured out of a container comprising the suspended insects, the degutted insects are brought onto a sieve after step b., liquid is sucked away after step b., insects are brought onto a filter after step b., etc., etc. Obviously, for the purpose of obtaining live degutted insects after step b. of the method, the applied separation step c. of the method should be sufficiently gentle such that the living insects stay alive during step c. of the method and thereafter. For example, in step b. of the method exposing BSF larvae for 45 minutes to 90 minutes, such as for about 1 hour, to water at a temperature of between 18° C. and 29° C., such as room temperature or ambient temperature, either when leaving the suspended insects standing still, or under periodic or constant gentle agitation or circulation, followed by step c. of the method comprising pouring the water from the degutted insects, provides live degutted BSF larvae, wherein the extent of degutting (degutting rate or efficiency) after step b. or step c. of the method is, for example, over 90% based on the weight of the gut content at the start of step b. of the method.

An embodiment is the method according to the invention, wherein the insect is black soldier fly, preferably black soldier fly larvae, more preferably, black soldier fly larvae 5 to 25 days of age, preferably 10-20 days post-hatching, most preferably black soldier fly larvae at a stage 6 hours - 4 days before prepupation of the larvae, such as 6 hours - 30 hours before prepupation of the larvae, or wherein the insect is mealworm. Subjecting BSF larvae which are at an age of 5 to 25 days post hatching and which are kept on feed such as a mixture of grain meal and potato meal in water (for example, 30-85% by weight water based on the total weight of the feed, such as 30-60%) during the period of 0 days till 5 days - 25 days, preferably 10-20 days post hatching (i.e. from the hatching up to the moment that the insects are subjected to the method of the invention), to the method of the invention, provides degutted larvae within a few hours such as after about 1 hour. The temperature is typically ambient temperature, or room temperature, such as 20° C.-25° C. Typically, for efficient degutting of BSF larvae, the larvae are sufficiently young relative to the moment at which the larvae turn into prepupa (turning darker), such that degutting efficiency (rate) is sufficiently high during the active phase of the insect development stages (larvae are more active than insects that turn into prepupa, or which are in their prepupa phase), since active larvae tend to swallow feed and liquid such as water to a higher extent than prepupa. That is to say, when insect larvae and mealworms are suspended in liquid, the content of the gut is expelled upon swallowing of the liquid surrounding the insects during step b. of the method, therewith providing degutted insects. For example, BSF larvae that are at an age of between 6 hours and 4 days before they turn into prepupa are sufficiently actively swallowing the liquid during step b. of the method, resulting in degutting to a large extent, e.g. over 50%, such as over 75%, over 85%. BSF prepupa stopped eating and do not swallow the liquid when subjected to step b. of the method. Therefore, the BSF larvae are at least at an age of 6 hours before they turn into prepupa, such that the liquid is actively swallowed by the insects, therewith stimulating the evacuation of the gut content into the liquid, and therewith filling the gut with the liquid, e.g. water.

An embodiment is the method according to the invention, wherein the liquid is an aqueous liquid or a liquid comprising water, preferably the liquid is any one of water, tap water, aqueous physiological salt solution at pH 5.5 - 8.5, aqueous physiological NaCl solution at pH 5.5 - 8.5, preferably pH 6.5 -7.5, and an aqueous citric acid solution at pH 5.0 - 7.5, more preferably the liquid is water or tap water, most preferably, the pH of the liquid is 6.5 - 7.5, and/or the liquid is water. In particular, the liquid is water, or the liquid is an aqueous salt solution at pH 5.5 - 8.5, such as an aqueous physiological salt solution, such as at pH 6.5 - 7.8, or 6.8 - 7.5. For the purpose of providing degutted insects, the liquid is a liquid selected for efficiently stimulating degutting of the insects. Efficient stimulation of degutting is achieved, for example, when the liquid provided in step a. of the method is a liquid that is conveniently and easily and readily swallowed (or eaten, taken in) by the suspended insects, such that evacuation of the gut is efficiently stimulated. Typically, liquids such as water, tap water, aqueous physiological salt solution at pH 5.5-8.5 such as 6.5-7.8, aqueous physiological NaCl solution at pH 5.5-8.5, preferably pH 6.5 - 7.5, and an aqueous citric acid solution at pH 5.0 - 7.5, are suitable for this purpose, although alternative liquids, solutions such as salt solutions, salt/sugar solutions or other solutions that are compatible with live insects and insect wellbeing, are equally suitable. In addition, when the insects are meant for processing steps for providing edible insects or edible insect derived products, the liquid applied in the method is a liquid that is preferably compatible with consumption by animals and/or by humans. Typically, liquids such as water, tap water, aqueous physiological NaCl solution at pH 5.5 -8.5, aqueous physiological salt solution at pH 5.5 - 8.5, preferably pH 6.5 - 7.5, and an aqueous citric acid solution at pH 5.0 - 7.5, are suitable for implication in the method, to this regard. Evacuation of insect gut is, for example, efficiently achieved when the liquid is water. ‘Efficiently’ is here understood as degutting of insects to an amount of at least 40% based on the weight of the gut content before the degutted insect is subjected to step b. of the method, preferably at least 55%, such as at least 90%. Most preferably, the pH of the liquid is 6.5 - 7.5, and/or the liquid is water.

An embodiment is the method according to the invention, wherein the predetermined temperature in step b. is above 12° C. and below 37° C., preferably 15° C. - 33° C., more preferably 18° C. -30° C., most preferably 20° C. - 28° C., such as 21° C. - 27° C. or 22° C. or 26° C., or wherein the temperature range in step b. is a range between from minimally 12° C. at the start of the incubation of step b. and maximally 37° C. at the end of said incubation or is a range between from maximally 37° C. at the start of the incubation of step b. and above 12° C. at the end of said incubation, preferably the temperature range is from 15° C. to 33° C. or from 33° C. to 15° C., more preferably from 18° C. to 30° C. or from 30° C. to 18° C., most preferably from 20° C. to 28° C. or from 28° C. to 20° C., such as from 21° C. to 27° C. or from 27° C. to 21° C. Without wishing to be bound by any theory, the method of the invention efficaciously provides degutted insects based on the active swallowing by the suspended insects of liquid during step b. of the method, the swallowing of the liquid resulting in pushing gut content through the gut and at least partly into the liquid, by replacing the gut content with the swallowed liquid such as water. The active swallowing of the liquid by live insects such as BSF larvae or mealworms, requires insects that are capable of actively taking in feed or liquid when exposed thereto. The inventors established that in the temperature range of between about 12° C. and about 37° C., the insects are capable of expelling their gut content into the liquid, when kept in the liquid at such a temperature. Although some degutting was also observed in the temperature range starting from 10° C. and higher. Most efficient degutting was observed in the temperature range referred to as room temperature or ambient temperature, e.g. 18° C. - 28° C., such as 21° C. - 27° C. or 22° C. - 26° C. Extent of obtained degutting was at least 50% when a temperature of the liquid during step b. of the method was selected within this range. Of course, the temperature may vary within the indicated range during the course of step b. of the method. Temperature may rise starting, for example, at 20° C. at the start of step b., ending at, for example, at 24° C. at the end of step b.

Preferred is the method according to the invention, wherein in step b. the predetermined time is between 5 minutes and 96 hours, preferably 10 minutes - 48 hours, more preferably 20 minutes - 24 hours, most preferably 30 minutes - 12 hours, such as 45 minutes, 1 hour, 1,5 hour. Degutting of insects by applying the method of the invention is a relatively fast and efficient approach when compared to current standard: 3 days fasting of insects such as BSF larvae and mealworms. Degutting efficiency (rate) of at least 50% is achieved when, for example, BSF larvae or mealworms are subjected to step b. of the method of 1 h (BSF larvae) or 1-2 days (mealworms), therewith saving time on the pre-slaughter time and steps required for providing degutted insects for the subsequent slaughter of the insects. Typically, the application of the method of the invention saves up to 3 days on processing time when BSF larvae are considered, which larvae are harvested, subjected to a degutting pre-slaughter step (degutting according to the method of the invention versus current practice: fasting for 3 days). When mealworms are considered, 1-2 days of time are saved. One of the several benefits of the method of the invention is the saving of time required for degutting, while the extent of degutting is at least as good and complete and efficient as the extent of degutting obtainable by applying current practice of degutting: fasting for 1-3 days. Moreover, degutted insects provided by the method of the invention comprise a higher content of fat and/or protein, and a lower content of microbes, based on the total weight of the insects and based on the total microbial count before degutting, respectively. That is to say, degutting by fasting, for example, fasting for 2-3 days, results in a decrease in the relative content of fat and/or protein in the insects, when the wt% of fat and protein after degutting is compared with that of before degutting, whereas degutting upon subjecting insects to the method of the invention results in at least maintenance of the fat and/or protein levels at the level present before degutting. Moreover, increase in fat and/or protein content is achieved by applying the degutting method of the invention, when the wt% of protein and/or fat is compared before and after degutting, based on the total weight of the insects before and after degutting, respectively. This effect is not obtained when applying current standard of degutting: fasting for days, such as 3 days. With the method of the invention, for BSF larvae, efficient degutting up to at least 90% is achieved already when the predetermined time in step b. of the method is 40 minutes to 3 hours, such as 1 hour. The BSF larvae stay alive and are retrieved as live degutted BSF larvae with the method of the invention. The gut is filled with liquid. Gut content is efficiently expelled into the liquid within 60-120 minutes, such as within 1 hour.

Preferred is the method for providing a degutted insect according to the invention, wherein the method consists of the steps of or wherein the method comprises the steps of:
a. providing an insect and providing a liquid at a predetermined temperature;
b. suspending the insect of step a. in the liquid of step a. and incubating the insect in the liquid for between 5 minutes and 96 hours at a temperature of above 12° C. and below 37° C. or at a temperature range between from minimally 12° C. at the start of the incubation and maximally 37° C. at the end of said incubation or at a temperature range between from maximally 37° C. at the start of the incubation and above 12° C. at the end of said incubation, therewith stimulating degutting of the insect and release of gut content of the insect into the liquid; and
c. at the end of the predetermined time of step b., optionally separating the insect of step b. from the liquid comprising gut content,
therewith providing the degutted insect by step b. or by optional step c. and providing liquid comprising gut content.

Preferred is the method according to the invention, wherein in step b. and in optional step c. the provided degutted insect is a live degutted insect, preferably a live black soldier fly larva or a live mealworm. Preferably, step c. of the method is performed, providing degutted insects such as BSF larvae free of liquid comprising the expelled gut content, and preferably the liquid is water.

Optionally, in the method according to the invention, the predetermined temperature in step b. is 15° C. - 33° C., preferably 18° C. - 30° C., more preferably 20° C. - 28° C., such as 21° C. - 27° C. or 22° C. or 26° C., or wherein the temperature range in step b. is a temperature range from 15° C. to 33° C. or from 33° C. to 15° C., more preferably from 18° C. to 30° C. or from 30° C. to 18° C., most preferably from 20° C. to 28° C. or from 28° C. to 20° C., such as from 21° C. to 27° C. or from 27° C. to 21° C.

Optionally, in the method according to the invention, the predetermined time is between 10 minutes - 48 hours, preferably 20 minutes - 24 hours, more preferably 30 minutes - 12 hours, such as 45 minutes, 1 hour, 1.5 hour. The inventors established that for BSF larvae 10-20 days of age post-hatching, such as at 14 days post-hatching, degutting was already apparent and occurred already at a significant extent and at a suitable extent useful for improved subsequent larvae processing steps after degutting, after a degutting period of as short as 20 minutes, when the larvae were taken up in water. Typically, the water was tap water. Typically, the water was at room temperature or somewhat below, e.g., 14° C. - 23° C., or 17° C. - 21° C. Without wishing to be bound by any theory, it is thought that at temperatures lower than the lower temperature limit indicated in the aspects of the invention and embodiments of the invention, such as 1° C. - 10° C. or below 12° C., the larvae are in hibernation, such that the larvae do not actively take in the water in which they are taken up. As a result, no degutting occurs. Without wishing to be bound by any theory, it is thought that at a temperature higher than 37° C. the larvae, such as BSF larvae, that are taken up in liquid such as water, are becoming increasingly active, such that they lose body weight and start to consume their protein- and fat reserves as a consequence of the absence of external feed source. As a result, although the larvae degut, the weight of the larvae decreases. Additionally, at such higher temperatures there is a risk for (increased) growth and expansion of microbes that may accidentally be present in the gut and at the larvae body surface. Microbial overgrowth may negatively influence the quality and/or health of the degutted larvae obtained and/or may even kill (part of the batch of) larvae. Therefore, the inventors established the optimal temperature range for the liquid that is applied for the degutting, such as water or tap water, which temperature range is typically 12° C. - 37° C.

As said, even after already a short incubation time of 20 minutes for BSF larvae in (tap) water at 22° C.-27° C., with larvae 10-14 days of age post hatching for example, degutting was apparent. Gut content became apparent in the water as established by visual inspection. In addition, the living larvae already turned lighter as an indication for the replacement of their gut content, which has a darker colour than water, with the water taken in by the living BSF larvae. For optimal degutting, a degutting time e.g. in water, e.g. at room temperature, a degutting time of longer than 20 minutes is beneficial. Typically, over 50% degutting or even over 75% degutting efficiency is achieved at e.g. room temperature, when BSF larvae are incubated in water for 1 hr - 72 hr, such as 1 hr, 3 hr, 6 hr, 24 hr, 28 hr, 48 hr or 72 hr.

Importantly, the method of the invention provides for a significant microbial count reduction when the degutted insects such as BSF larvae are considered, when compared to the BSF larvae that are not subjected to the method of the invention, e.g., not subjected to a degutting process.

An embodiment is the method according to the invention, wherein in step b. or in optional step c. the provided degutted insects are live degutted insects, preferably live black soldier fly larvae or live mealworms. For the live insects, the risk for microbial (over)grown is reduced, compared to when the insects would die during the incubation in the liquid such as the (tap) water. An embodiment is the method according to the invention, wherein in step b. and in optional step c., when applied, the provided degutted insect is a live degutted insect, preferably a live black soldier fly larva or a live mealworm, or wherein in step b. or in optional step c. the provided degutted insect is a dead degutted insect, preferably a dead black soldier fly larva or a dead mealworm.

The method of the invention is a relatively low-cost method when energy requirements is considered: taking insects such as live larvae such as live BSF larvae up in water at, e.g., room temperature or (tap) water at, e.g., 15° C.-25° C. saves energy and is less cumbersome since it does not require for example the heating and/or cooling of the water since water at room temperature for example can be applied in the method. In addition, the method of the invention is applicable at any intended scale from a few hundred grams up to several tons of insects such as living BSF larvae. That is to say, the inventors have successfully applied the method with a sub-kg amount of BSF larvae and mealworm, and also at a scale of several tons of BSF living larvae, degutted and stored in a silo with a size for encompassing up to 6 ton of larvae in water. There are no limitations to the scale for the method.

The mass or volume ratio between insect such as BSF larvae, and (tap) water during the degutting is typically 1:1, or lower. Typically, the mass ratio insect larvae (:) water in the method step is 0.02 (:) 1 to 0.7 (:) 1, for example between 0,05 (:) 1 and 1 (:) 1, or between 0.07 (:) 1 and 0.7 (:) 1, such as 0.1 (:) 1 or 0.2 (:) 1 or 0.5 (:) 1. For example, the ratio amounts to about 75 gram insect larvae admixed with 1 liter water, or about 150 gram insect larvae admixed with 1 liter water, or about 300 gram insect larvae admixed with 1 liter water, or about 650 gram insect larvae admixed with 1 liter water. A typical mass ratio of one part larvae such as black soldier fly larvae and 7-13 parts water, for example 10 parts water, is applied in the method.

One of the many benefits of the degutting method is the provision of a stable and robust method when the extent and quality of degutting is considered when comparing various batches of degutted insects provided with the method, since incubating in water for a determined time period at a determined temperature is controllable without much effort, and the method is in this regard more robust and controllable than a method known in the art implying heating steps.

Important differences, i.e. improvements for the degutted (BSF) larvae, obtained with the method of the invention, versus live larvae such as live BSF larvae which are not degutted (or which are degutted by starving the larvae), are amongst others: (i) a reduced microbial count; (ii) an improved color in the sense that insect puree obtained from larvae provided with the method of the invention has a lighter overall appearance and color; and (iii) a higher crude protein content and/or a higher crude fat content, e.g. both a higher crude protein content and a higher crude fat content.

The method of the invention provides live degutted insects when, for example, the insects are subjected to the step b. of the method for minutes to 1 day, for example, 30 minutes - 12 hours. Typically, live BSF larvae that are degutted for at least 75%, such as > 90% are provided with the method, e.g. with step c. of the method, when the larvae are subjected to step b. of the method for less than 4 hours, preferably less than 3 hours such as less than 90 minutes, about 1 hour. For the purpose of subsequent processing the degutted insects after subjecting the insects to the method, it is beneficial to subject live insects to the subsequent processing step such as controlled killing or slaughtering the insects. This way, the optimally fresh insects are subjected to processing steps, for example, without the need of preservation steps that would otherwise be required or essential when the degutted insects would be dead insects provided by the method. Of course, it is also part of the invention that the method provides dead degutted insects. For example, dead degutted mealworms are provided with the method, when the degutting time in step b. of the method is 3-4 days, and the temperature is room temperature, and the liquid is water. At least part of the mealworms are dead mealworms, according to the invention, although also at least part of the mealworms can be live mealworms. Preferably, the liquid is water, such as tap water, and preferably the temperature during step b. of the method is room temperature or 17° C. - 26° C., and preferably for BSF larvae the time duration of step b. of the method is less than 6 hours such as about 1 hour.

Therefore, one of the several benefits of the method of the invention is the possibility to provide live degutted larvae (with a relatively low microbial count), since live larvae have an active immune and circulatory system, which keeps the live larvae fresh and safe and suitable for use as feed/food or as an ingredient in food or feed, compared with dead (wet) larvae. Furthermore, the live degutted larvae such as live degutted BSF larvae are suitable for use in feeding to for example chicken, wherein the fact that the larvae are alive contributes to the well-being of the chicken that search and pick the larvae, which is a benefit not obtainable with dead degutted larvae. In addition, the live larvae come with a lower risk for microbial contamination than the dead degutted larvae. Of course, also the dead degutted larvae are suitable for feeding to e.g. chicken. In addition, both live degutted larvae and dead degutted larvae, obtained with the method of the invention, are suitable for a next step after degutting, comprising processing the larvae for production of puree, or for (subsequent) protein/fat extraction from e.g. minced and heated larvae. However, in view of the relatively low microbial count, starting the processing with live degutted BSF larvae is preferred.

An embodiment is the method according to the invention, wherein in step a. the provided insect is an insect that was fed, preferably fed ad libitum, up till 0 minutes - 12 hours before the insect is being subjected to step b. of the method, preferably 0 minutes - 6 hours, more preferably 0 minutes - 3 hours, most preferably 0 minutes 2 hours, such as fed ad libitum up to 0 minutes before the insect is being subjected to step b. of the method, or 10 minutes, 20 minutes, 30 minutes, 45 minutes or 1 hour before the insect is being subjected to step b. of the method. An embodiment is the method according to the invention, wherein in step a. the provided insect is an insect that was fed up till 0 minutes - 12 hours before the insect is being subjected to step b. of the method, preferably 0 minutes - 6 hours, more preferably 0 minutes - 3 hours, most preferably 0 minutes 2 hours, such as fed up to 0 minutes before the insect is being subjected to step b. of the method, or 10 minutes, 20 minutes, 30 minutes, 45 minutes or 1 hour before the insect is being subjected to step b. of the method. Typically, insects are kept in a container comprising insect feed, such that the insects have continuously access to feed, up to the moment at which the insects are harvested: insect feeding ad libitum. Typically, the inventors harvested the insects from their cages (containers) shortly before the insects are subjected to the method of the invention: preferably 0 - 60 minutes. The containers comprised substrate, i.e. a mixture of feed and insect remains, excrements. Preferably, before insect harvesting, the insects are kept in a container that comprises substrate comprising insect feed, such that insects have access to feed and can eat up till the harvesting. Typically, according to the invention, insects have access to feed according to scheduled feedings and/or ad libitum, wherein the scheduled feedings can be scheduled such that feeding is ad libitum.

One of the many benefits achieved with applying the degutting method of the invention is that the insects subjected to the method do not have a decreased fat content and/or decreased protein content when the amount of fat and protein as a wt% of the total weight of the insects before and after subjecting the insects to the method is considered. In contrast, fat content and protein content of degutted insects obtained with degutting by fasting, are decreased when compared to fat content and protein content in the insects before subjected to fasting for the purpose of degutting. Subjecting insects to the degutting method shortly after the insects are harvested from an environment where the insects had access to feed, contributes to optimal weight of the insects prior to processing and slaughter of the insects, the optimal weight relating to highest fat content achievable and highest protein content achievable in the insect. Subjecting insects to the method of the invention directly after harvesting of the insects from their environment in which they have access to feed, or shortly after said harvesting (i.e. for example, within 12 hours, preferably within 1 hour, more preferably within 0-30 minutes), improves the yield of protein and/or fat from the processed insects after said insects are subjected to the method of the invention. Avoidance of a fasting period, or limiting the fasting period for the insects that are subjected to the method, contributes to optimal degutted insect yield when total weight of the degutted insects is considered, and when fat content and protein content is considered. For the degutting method it is not required that the insects are pre-fasted before being subjected to the method of the invention. Absence of such a pre-fasting time period prior to subjecting insects to the degutting method contributes to the beneficial time saving achieved when the method of the invention replaces currently applied methods of fasting of insects for the purpose of invoking degutting while giving in on fat yield and protein yield after slaughter and processing of such insects after fasting.

An embodiment is the method according to the invention, wherein in step b. 1% by weight -25% by weight gut content of the insect is excreted from the insect into the liquid, based on the total weight of the insect provided in step a., preferably 2% - 22%, more preferably 3% - 17%, most preferably 4% - 14%, such as 5%, 7%, 10%, 12%, 20%. When such amount of gut content is expelled from the insect gut during step b. of the method, at least 50% of the gut content is evacuated from the degutted insect, typically over 80% or even at least 90%. Such amounts of degutted gut content results in degutted insects for which about 35% - 95% of their gut content is evacuated and/or replaced by the liquid.

An embodiment is the method according to the invention, wherein in step b. or in optional step c. 0.5% by weight - 30% by weight of the degutted insect consists of the liquid provided in step a., based on the total weight of the insect provided in step a., preferably 1% - 22%, more preferably 2% - 19%, most preferably 3% - 17%, such as 4%, 7%, 10%, 14%, 23%. When the weight of the degutted insect is build up by such an amount of liquid in the gut of the degutted insect, at least about 35% of the gut content is evacuated into the liquid during step b. of the method, such as at least 45% or at least 85%. The liquid in the degutted insect is present in the gut and replaces the expelled gut content, now present in the liquid surrounding the degutted insects at the end of step b. of the method.

An embodiment is the method according to the invention, wherein in step b. or in optional step c. the total microbial count of the degutted insect is lower than the total microbial count of the insect provided in step a. of the method, preferably at least two times lower, preferably at least 4 times lower, more preferably at least 6 times lower, most preferably at least 10 times lower, such as 2 - 50 times lower, 4 - 30 times lower, 6 - 25 times lower, or 9 times lower, 15 times lower, 18 times lower, 25 times lower, said total microbial count, for example, established as the total microbial count on a plate after 16 h culturing. The inventors established that subjecting insects to the degutting method of the invention results in degutted insects which have a relatively low microbial count when, for example, the microbial count of minced degutted insects such as BSF larvae is compared to the microbial count of minced insects that were degutted by fasting for 3 days, or is compared to the microbial count of minced insects that were not subjected to a degutting step. Typically, degutting by applying the method of the invention results in a 5 - 20 times lower microbial count in and/or on the insects when compared to non-degutted insects, as assessed after subjecting the insects to a mincing step, therewith providing insect puree, in which the microbial count was determined. The microbial count is typically assessed using the plating method and applying overnight incubation before counting (about 16 hours incubation), according to methods known in the art. Thus, by subjecting insects such as BSF larvae or mealworms to the degutting method of the invention, degutted insects are provided that contain a relatively low microbial burden or count, compared to insects provided otherwise, such as insects obtained after conventional fasting for 1-3 days such as 3 days, or insects that were not subjected to a degutting method. One of the benefits of providing degutted insects with a lower microbial count by applying the method of the invention, is improved quality of insect based products obtained by processing such cleaner degutted insects, such improved quality relating to a lower microbial count directly after processing and thereafter, relating to improved product safety, and/or less influence of microbes on taste, smell, appearance, etc., and/or improved shelf live, and/or less risk for food poisoning when animal or human consumers of the product are concerned, etc.

An embodiment is the method according to the invention, wherein in step b. or in optional step c. the B.cereus count and/or the E.coli count of the degutted insect is lower than said count(s) for the insect provided in step a. of the method, preferably at least two times lower, preferably at least 4 times lower, more preferably at least 6 times lower, most preferably at least 10 times lower, such as 2-50 times lower, 4-30 times lower, 6-25 times lower, or 9 times lower, 15 times lower, 18 times lower, 25 times lower, said count(s) in cfu/g per gram degutted insect provided with step b. or provided with optional step c. and in cfu/g per gram insect provided in step a., respectively. It is also part of the invention that the microbial count in so far these microbes are concerned, is lower for the degutted insects provided with step b. or c. of the method, when compared to the microbial count of degutted insects obtained by conventional fasting of the insects, in particular when BSF larvae and/or mealworms are considered. Obviously, a lower count of B.cereus and/or E.coli for the degutted insects provided with the method of the invention is beneficial when food/feed safety is concerned for products obtained from processed degutted insects.

An embodiment is the method according to the invention, wherein in step a. the insect is black soldier fly larvae 12-24 days of age post hatching, preferably 6 hours -2 days before prepupation of the larvae, and/or in step a. the provided insect is an insect that was fed (ad libitum) up till 0 minutes -1.5 hours before the insect is being subjected to step b. of the method, and/or the liquid is water or tap water, and/orthe predetermined temperature of the liquid in step a. and step b. is 18° C. - 28° C., preferably 21° C. - 27° C., and/or the predetermined time in step b. is 30 minutes - 1.5 hours, preferably 50 minutes - 80 minutes, and/or wherein in step b. or in optional step c. the provided degutted insect is a living degutted insect, preferably, in step a. the insect is black soldier fly larvae 18-24 days of age post hatching and 6 hours - 30 hours before prepupation of the larvae, and in step a. the provided insect is an insect that was fed (ad libitum) up till 0 minutes - 1 hour before the insect is being subjected to step b. of the method, and the liquid is water or tap water, and the predetermined temperature of the liquid in step a. and step b. is 19° C. - 27° C., and the predetermined time in step b. is 45 minutes - 75 minutes, and in step b. or in optional step c. the provided degutted insect is a living degutted insect. Degutted insects provided this way are particularly suitable for subsequent insect processing steps used in methods for applying food-grade and/or feed-grade insect-derived products, insect-based products and/or whole insects, for example, dried insects, grilled insects, minced insects, oil derived from such insects, etc. Typically, feed and food grade degutted BSF larvae are provided with the method of the invention, when microbial count is considered, or for example, when fat/oil content and/or protein content is considered. Similarly, with the method of the invention, degutted mealworms are provided, suitable for further processing into feed products, feed ingredients, food applications, etc. The insects are, for example, kept in a container comprising sufficient feed for all insects up till the harvest and the provision of the insects in step a. of the method.

An embodiment is the method according to the invention, wherein the insect is black soldier fly larvae that were fed a feed consisting of a mixture of grain meal, potato meal and water, before being subjected to step a. of the method. It is also part of the invention that the feed fed to the insects is low in microbial count, or even free from microbes, ‘free’ in the context of the method of the invention to be understood as a microbial count lower than the microbial count seen for degutted insects provided with the method of the invention (See for example, the Example 1 with BSF larvae, in the examples section, here below). Typically, such feed has a microbial count on the plate of at most 3 million, for example, 2 million or less. In essence, the lower the microbial count in the grain meal/potato meal/water mixture, the lower the microbial count in the gut content of the insects is to be expected. Typically, the relative amounts of grain meal and potato meal in the BSF larvae feed is 1:1 or 2:1 or 1:2, or any ratio in between, wherein the water content is typically at least 30% such as 45%-85% based on the total weight of the feed.

An embodiment is the method according to the invention, wherein the absolute weight amount of lipid and fat of the degutted insect provided with step b. or with optional step c. of the method is at least 80% of the absolute weight amount of lipid and fat of the insect provided in step a. of the method, preferably at least 85%, more preferably at least 90%, most preferably at least 95%, such as at least 97%, at least 98%, at least 99%, at least 99, 5%, such as 100% - 125%, and/or wherein the absolute weight amount of protein of the degutted insect provided with step b. or with optional step c. of the method is at least 80% of the absolute weight amount of protein of the insect provided in step a. of the method, preferably at least 85%, more preferably at least 90%, most preferably at least 95%, such as at least 97%, at least 98%, at least 99%, at least 99, 5%, such as 100% - 125%. The inventors established that with insects such as BSF larvae, that are subjected to the method of the invention, the fat content in the degutted insect is at least as high as the fat content in the insects that were not subjected to a degutting method, and at least as high as the fat content in insects that were subjected to degutting by fasting. Similarly when the protein content of the degutted insects according to the method of the invention are considered. That is to say, subjecting insects to the degutting method of the invention does not result in a decrease of their relative fat content based on the total weight of the degutted insect and when compared to the fat content of the insects before degutting. In some embodiments, an increase in the relative fat and/or protein content is obtained when insects are subjected to the method of the invention, compared to fasted insects or when compared to insects not degutted.

An embodiment is the method according to the invention, wherein at the end of step b. of the method at least 25% by weight gut content of the insect is excreted from the insect into the liquid, based on the total weight of the gut content in the insect provided in step a., preferably at least 40%, more preferably at least 60%, most preferably at least 70%, such as 25% - 90% or 25% - 100%. The inventors established that by applying the method of the invention for degutting insects such as BSF larvae or mealworms, the extent of degutting after step b. or after step c., if applied after step b., is at least 25%, such as at least 30%, increasing to at least 90% for some insects and selected combinations of predetermined incubation time in step b. of the method, selected temperature or temperature range in step b., and type of liquid. Typically, at least 40% gut evacuation is achievable when the liquid is water, the degutting time during step b. is between 1 hour and 2 days, such as 1 hour, 12 hours, 1 day, 2 days, and the temperature is between 18° C. and 27° C. such as room temperature or ambient temperature. For example, when BSF larvae 14 days - 22 days of age post hatching are subjected to the method of the invention directly following harvesting from feed substrate or within 5 minutes - 1 hour after harvest from feed substrate, extent of degutting is at least 70% such as at least 80% or even at least 90%. Similar results are obtained with the method of the invention when mealworms are subjected to the method for 2 days in step b. of the method. These degutting rates for the insects are not obtainable with the conventional degutting method of fasting insects for about 3 days, as currently applied, to the best of the knowledge of the inventors. The invention thus provides a method that supplies degutted insects with an increased extent of gut evacuation, compared to methods in the art.

An embodiment is the method according to the invention, wherein at the end of step b. of the method or in optional step c. at least 30% by weight of the gut content in the degutted insect consists of the liquid provided in step a., based on the total weight of the gut content in the insect provided in step a., preferably at least 40%, more preferably at least 50%, most preferably at least 60%, such as 30%-95% or 30%-100%. As said before, it is believed, without wishing to be bound by any theory, that the degutting method of the invention involves the swallowing of the liquid by the insects subjected to the method, wherein the swallowed liquid such as water essentially replaces the gut content in the gut of the insects, the gut content expelled out of the insect this way. Therefore, the extent of degutting relates to the volume or weight of liquid inside the gut at the end of step b. of the method. The more liquid accumulates inside the gut of the insects, the more gut content is excreted into the liquid, accordingly, contributing to the beneficial effects of degutting on insect quality, e.g. when the insect is subsequently subjected to processing steps for providing insect derived or based feed or food or feed or food ingredients.

An embodiment is the method according to the invention, wherein in step b. the predetermined time is between 5 minutes and 10 hours, preferably 10 minutes - 6 hours, more preferably 20 minutes - 3 hours, most preferably 30 minutes - 2 hours, such as 40 minutes, 50 minutes, 1 hour, 30 minutes -90 minutes. For BSF larvae that are subjected to the method for degutting according to the invention, the inventors surprisingly found that a degutting time in step b. of the method as short as 1 hour is sufficient and enough for achieving maximal achievable degutting, i.e. >90% degutting when the weight of the gut content is considered based on the total weight of the gut content present at the start of step b. of the method. Even over 50% degutting is already achieved when the predetermined time in step b. of the method is shorter than 1 hour such as 45 or 30 minutes. One of the beneficial effects of the method of the invention is that with such short degutting times in step b., the BSF larvae stay alive, such that the method after step b. or c., when applied, provides live degutted insects. Live insects are suitable for direct processing into products, and are suitable for (limited) storage before being subjected to processing steps, e.g. without the need for preservatives or preservation measures, that would otherwise be necessary and required when dead insects were provided with a degutting method, such as occurs to a certain extent when larvae are fasted for up to three days. In addition, microbial growth on and in live degutted insects such as BSF larvae is lower than microbial growth on and in dead insects such as non-degutted dead insects and starved insects, and on and in live non-degutted insects and live starved insects. See also the examples section, Example 1, here below.

An aspect of the invention relates to a degutted insect wherein the gut of the insect is at least partly filled with liquid.

Preferred is the degutted insect wherein the gut of the insect is at least partly filled with liquid, wherein preferably the degutted insect is a living black soldier fly larva, preferably 10-14 days of age post hatching, wherein the liquid preferably is water such as tap water, and wherein preferably the degutted insect has taken in feed up to a time point 30 minutes - 3 hours in the past. That is to say, to their surprise, the inventors provide a living BSF larvae e.g. 10-14 days of age post hatching, that has taken in feed up to a short period of time, e.g. 30 minutes - 3 hours of time, before the degutted insect is provided, while still a substantial amount of the gut content of the insect has been replaced with water, while the insect is still alive and did essentially not lose weight due to starvation. To the knowledge of the inventors, they are the first who provide living larvae that are degutted for at least 50%, wherein the gut is filled with water, while the time from the last feeding of the larvae up to the provision of degutted larvae is as short as 30 minutes, 1 hr, 2 hr, 3 hr, etc. such as 20 minutes - 4 hr, 90 minutes - 2.5 hr, therewith preventing loss of valuable insect protein and insect fat due to starvation of the insect, which occurs with methods known in the art (e.g. starvation for 1-3 days). Keeping insects alive while degutting improves the quality of the processed insects afterwards, since microbial burden is lower than when insects would die during degutting processing and/orwhen starving during degutting. In the process of the invention, degutting is a fast process (e.g. 30 minutes - 90 minutes), insects stay alive, and microbial burden decreases due to expelling gut content from the larvae. According to the inventors, there is no other method available that could provide live degutted insects provided by the method of the invention, and as exemplified for the living black soldier fly larvae 10-14 days of age, which are filled with water and degutted for over 50% such as over 60%, over 70%, over 80%, wherein the gut content is replaced by water, wherein the degutted larvae were fed shortly, e.g. 30 minutes - 4 hours, before being provided as degutted insects wherein the gut of the insect is at least partly replaced with liquid.

An embodiment is the degutted insect according to the invention, wherein the insect is black soldier fly, preferably black soldier fly larvae, or wherein the insect is mealworm, and/or the liquid is water or tap water, and/or wherein the liquid in the gut of the insect amounts to at least 5% by weight based on the total weight of the insect, preferably 5% - 25%, more preferably 8% - 22%, and/or wherein the degutted insect is a living insect, preferably the insect are living black soldier fly larvae, and preferably the liquid is water or tap water.

An embodiment is the degutted insect according to the invention, wherein the degutted insect is obtained with the method of the invention, or wherein the degutted insect is obtainable by the method of the invention. An embodiment is the degutted insect according to the invention, wherein the degutted insect is a live insect such as a live BSF larva or a live mealworm, or wherein the degutted insect is a dead insect such as a dead BSF larva or a dead mealworm. Preferably, the degutted insect is a live BSF larva or a dead mealworm.

An aspect of the invention relates to the use of the (live or dead) degutted insect according to the invention for the provision of processed degutted insect, the processing comprising, for example, any one or more of mincing, cutting, particulating, grinding, pressing, crunching, drying, heating, blanching, lyophilizing, fractioning, hydrolyzing degutted insect, and any combination thereof. Of course, it is also part of the invention that the degutted insects provided with the method of the invention can be a mixture of live and dead insects, obtained at the end of step b. and step c., when applied, of the method. For example, the method provides in step b. or step c. a mixture of 5-100% live insects and 95-0% dead insects, or 0-100% dead insects and 100-0% live insects, although provision of (near) 100% live insects such as BSF larvae with the method of the invention is preferred. For mealworm, for example, the method provides 50-100% dead degutted mealworms. An embodiment is the method of the invention, wherein at least 5% of the insects provided with step b. and, if applied, with step c. of the method are live insects, such as live BSF larvae or live mealworms, preferably at least 25%, at least 50%, at least 80%, at least 90% or at least 95%. An embodiment is the method of the invention, wherein at least 5% of the insects provided with step b. and, if applied, with step c. of the method are dead insects, such as dead BSF larvae or dead mealworms, preferably at least 25%, at least 50%, at least 80%, at least 90% or at least 95%.

An aspect relates to the use of the (live or dead or a mixture thereof) degutted insect according to the invention or the use of the processed degutted insect of the invention for the separation of the degutted insect or of the processed degutted insect in at least a fat fraction and/or at least a protein fraction, preferably in both a fat fraction and a protein fraction, wherein preferably the fat fraction comprises at least 35% by weight insect fat based on the total dry weight of the degutted insect or the processed degutted insect, more preferably at least 38%, such as 38% - 42%, and/or wherein preferably the protein fraction comprises at least 40% by weight insect protein based on the total dry weight of the degutted insect or the processed degutted insect, more preferably at least 45%, such as 44% - 50%.

An aspect of the invention relates to an insect product, wherein the insect product is insect puree obtained from degutted insect, wherein the degutted insect is preferably provided with the method of the invention or obtained from the degutted insect of the invention or obtained from the processed degutted insect of the invention.

An aspect of the invention relates to an insect product, wherein the insect product is insect powder, particulate insect, ground insect, granulated insect, or insect meal, obtained from degutted insect, wherein the degutted insect is preferably provided with the method of the invention or obtained from the degutted insect of the invention or obtained from the processed degutted insect of the invention.

An aspect of the invention relates to an insect product, wherein the insect product is dried insect, oven-dried insect, lyophilized insect, or oven-dried insect using refractive drying, obtained from degutted insect, wherein the degutted insect is preferably provided with the method of the invention or obtained from the degutted insect of the invention or obtained from the processed degutted insect of the invention.

An aspect of the invention relates to an insect product, wherein the insect product is insect gut content, wherein the gut content is preferably provided with the method of the invention.

An embodiment is the insect product according to the invention, wherein the insect is black soldier fly, preferably black soldier fly larvae, or wherein the insect is mealworm. One of the manifold benefits of the application of the degutting method of the invention, for example, with BSF larvae, is that the degutted insects obtained with the method comprise less enzymes involved in inducing color change of the degutted insects or of the insect products derived therefrom such as the insect products according to the invention. Reference is made to Example 1 here below, showing that color change with degutted BSF larvae is not observed when the larvae are minced into puree, whereas puree from starved or non-degutted larvae turns gray to black within hours, or whereas such puree obtained from insects not subjected to the method of the invention is already brownish-grayish directly after mincing the larvae obtained with the method, since the BSF larvae already at least in part turned into prepupae during e.g. the period of starvation lasting for 3 days. With a degutting time frame of as short as 1 hour, resulting in >90% degutting, prepupation cannot occur when the BSF larvae subjected to the degutting method of the invention have an age of, for example, 6 hours to 2.5 days before prepupation would occur. The degutting method of the invention thus provides a more stable, more appealing product when, for example, BSF larvae puree is produced with degutted insects obtained with the method, when compared to discoloration observed for puree obtained with starved and otherwise similar BSF larvae.

An embodiment is the use of the degutted insect according to the invention, wherein the insect is black soldierfly, preferably black soldier fly larvae, orwherein the insect is mealworm. An embodiment is the use of the degutted insect according to the invention, wherein the insect is larvae of the black soldier fly (Hermetia illucens).

### Some Embodiments

Gastrointestinal evacuation in black soldier fly larvae - In current post-harvest processing system of industrial BSF production, the BSF larvae are minced and homogenized before protein extraction and fat extraction. The quality of minced product (= puree) can potentially be affected by the gastrointestinal materials of the insect that are poor in nutrition and rich in microbes and digestive enzymes. Thus, the quality of minced BSF larvae is affected by the gastrointestinal materials of the insect that are poor in nutrition and rich in microbes and digestive enzymes. In the art, post-harvest starvation has been suggested as a gastrointestinal evacuation (GE) method in BSF. However, no direct evidence is available for GE and improvement of the quality of larvae after starvation. The current inventors now determined the GE through dissection of BSF larvae that were kept under different temperature conditions and substrate conditions, i.e., (1) in the rearing substrate (comprising feed), (2) in water, and (3) no substrate (fasted)] after harvest. Different GE patterns are observed, depending on the environmental condition after harvest, when the BSF larvae are subjected to the method of the invention. At relatively low temperature (10° C.), GE was not completed (completion set at > 90%). The most complete GE was observed after 6 h incubation in water during step b. of the method, and after 48 h under fasting as well as in rearing substrate. Shortening the pre-slaughter period is important to avoid the decline of nutritional and microbial qualities of BSF larvae. The highest level of gut evacuation in the shortest time (1 h) was obtained in the BSF larvae that had been kept in water at room temperature. Interestingly and to the surprise of the inventors, further investigations indicated improvements in the nutritional qualities, improvements in color qualities, and improvements in microbial qualities of the BSF larvae after GE in water. These BSF larvae showed higher crude protein and fat content, lower microbial content, lower wet weight, lighter puree color, and no change in their dry weight content, ash content, and fibre contents, compared with the BSF larvae that had been kept in the rearing substrate (i.e. the BSF larvae provided in step a. of the method of the invention). The inventors thus established an optimized degutting method for insects such as the BSF larvae, using a water bath, after harvest of the insects, to improve the quality of insets such as BSF larvae, meant for subsequent processing. Further reference is also made to the claims and the Example 1 in the example section, here below.

While the invention has been described in terms of several embodiments, it is contemplated that alternatives, modifications, permutations and equivalents thereof will become apparent to one having ordinary skill in the art upon reading the specification and upon study of the drawings. The invention is not limited in any way to the illustrated embodiments. Changes can be made without departing from the scope which is defined by the appended claims. The embodiments of the invention described herein can operate in combination and cooperation, unless specified otherwise.

The invention is further illustrated by the following examples, which should not be interpreted as limiting the present invention in any way.

### EXAMPLES

### Example 1: Black Soldier Fly

### Materials and Method

### Insects

Black soldier fly (BSF) larvae were reared from a batch of eggs collected for a maximum of 24 hours from breed cages (Protix, Dongen, The Netherlands). Rearing of the larvae was conducted using two types of feed: Feed (1) regular commercially available chicken feed, known in the art (chicken palette (28%) + wheat bran (10%) + water (62%), based on the total weight of the BSF larvae fee), and Feed (2) regular BSF larvae feed, essentially consisting of a mixture of grain meal and potato meal in water (water content approximately 40%-45% by weight based on the total weight of the feed). For each type of the two feed, about 40.000 larvae were bred in a crate. About 20 g BSF eggs was placed in each crate with a distance of ~ 10 cm from the surface, to allow hatching. Egg harvest day was considered as day 0. On day 8, a group of 16.000 larvae from each crate was transferred to another crate with 20 kg of the same feed for rearing. Rearing room was kept at 27° C. from day 0 till day 8, at 32° C. from day 8 to day 10, and at 22° C.-24° C. from day 10 to day 14. Relative humidity was 80 ± 5% during the whole course of 14 days.

### Determination of Gut Evacuation

### Sampling

Gut evacuation (degutting) was determined in BSF larvae kept under different temperature conditions and substrate conditions (in total (3 × 3 =) 9 treatments, Table 1) after harvest of the larvae at day 14 post hatching. For each treatment, about 1.000 BSF larvae were allocated. The BSF larvae were either kept on the same feed from day 14 onwards, or the larvae were depleted from feed (fasted).

TABLE 1

The environmental conditions under which BSF larvae were kept after harvest at day 14 post hatching are depicted, for determining larvae gut evacuation over time

| Treatment | Temperature | Substrate^{‡} |
|---|---|---|
| 1 | 10° C. | No rearing substrate (fasted) |
| 2 | 10° C. | Rearing substrate |
| 3 | 10° C. | Water |
| 4 | Room temperature (22° C.-27° C.) | No rearing substrate (fasted) |
| 5 | Room temperature (22° C.-27° C.) | Rearing substrate |
| 6 | Room temperature (22° C.-27° C.) | Water |
| 7 | 35° C. | No rearing substrate (fasted) |
| 8 | 35° C. | Rearing substrate |
| 9 | 35° C. | Water |

‡: rearing substrate is a mixture of insect feed and insect residues, accumulating during the time the insects are contacted with the feed.

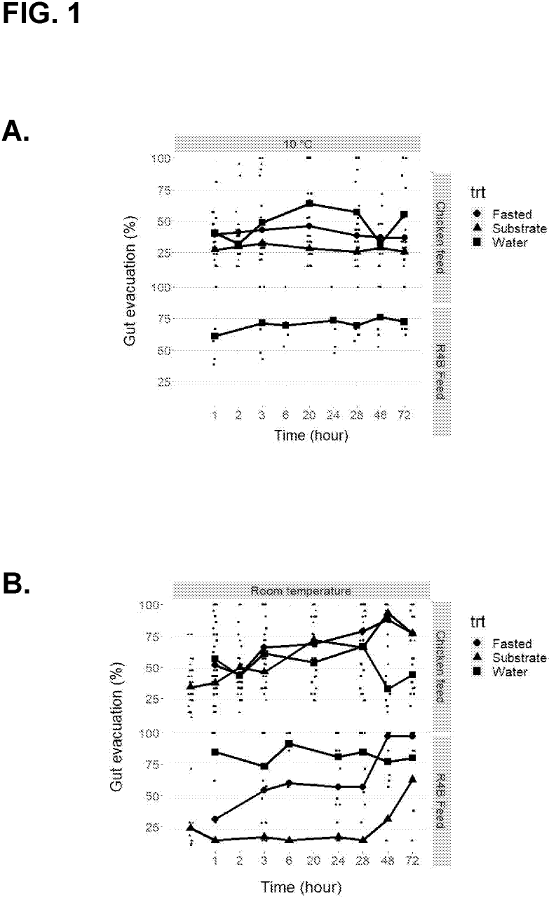

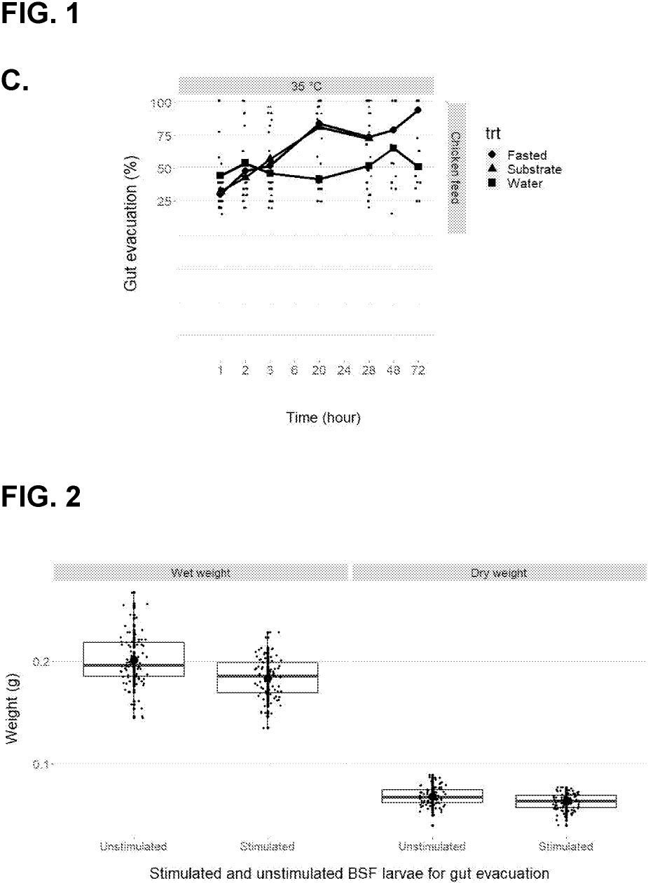

At the harvest moment (day 14 post hatching) and at different time intervals after that (FIG. 1), a random sample of about 50 larvae from each treatment was transferred to a freezer and the BSF larvae were kept at -18° C. to fix the position of feed in their gut.

### Visual Determination of Gut Evacuation

To determine gut evacuation (degutting) the frozen larvae were dissected, and their gastrointestinal tract was observed (visually inspected) under a stereomicroscope in a phosphate-buffered saline (PBS) solution with the pH of 7.4, known in the art. Gut evacuation was graded as follows: 0 = no evacuation/full of solid materials, 1 = full of dark-colored liquid materials, 2 = full of transparent liquid materials, and 3 = complete evacuation/no solid materials and/or no liquid materials. The gut evacuation grade was recorded for the following six distinct areas of the insect gut according to Bonelli et al. (2019): (1) foregut (FG), (2) anterior midgut (AMG), (3) mid midgut (MMG), (4) posterior midgut (PMG), (5) anterior hindgut (AHG), and (6) posterior midgut (PMG).

### Impact of Degutting on the Quality of BSF Larvae

The highest level of gut evacuation in the shortest time (1 h) was observed in the BSF larvae that had been kept in water at room temperature (about between 22° C. and 27° C.). The effect of treatment of the BSF larvae in water at room temperature for 1 h on the color of BSF larvae puree obtained by mincing of the larvae, microbial content of the minced larvae, and nutritional qualities of the larvae, was assessed. Two groups of larvae reared in the same crate were compared: Group (1) was stimulated for degutting, i.e., the larvae were kept in a water bath at room temperature for 1 hour (hereafter referred to as: ‘stimulated’), and Group (2) were unstimulated larvae which were sampled from the feed substrate at the same time as the sampling of the stimulated larvae (hereafter referred to as: ‘unstimulated’). The larvae that were used for nutrition analysis and wet- and dry weight measurements had been reared in the BSF larvae grain/potato feed. Microbial count assessment and color measurements were conducted on the larvae that had been reared in the chicken feed.

### Nutrition

For nutrition analysis, about 200 g larvae in 8 replicates (600 g in total) from each group of stimulated and unstimulated larvae were sampled. The larvae were washed under running tap water for ~ 30 seconds and then transferred into a freezer at -18° C. prior to sending to Nutrilab (Rijswijk, The Netherlands) for analysis. Moisture, dry matter, crude protein, crude fat, crude fiber, and crude ash measurements were conducted by Nutrilab.

### Wet Weight and Dry Weight

Stimulated and unstimulated larvae were also compared in terms of their wet and dry weights. About 200 g larvae from each group of stimulated and unstimulated larvae were sampled. The larvae were washed under running tap water for ~30 seconds and then the washed larvae were transferred into a freezer at -18° C. After 24 hours, 80 frozen larvae from each group were individually weighed and transferred into an oven at 103° C. for 4 hours to dry and measure their dry weight as well.

### Color

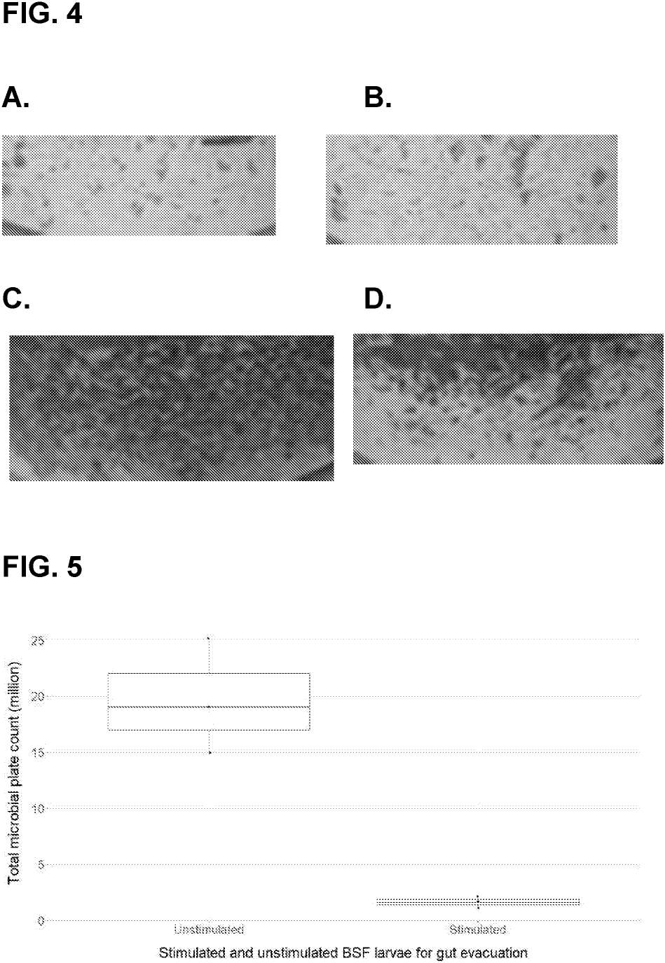

Without wishing to be bound by any theory, polyphenol oxidase enzymes are responsible for darkening over time of the slaughtered and minced BSF larvae (puree). Again without wishing to be bound by any theory, degutting of the BSF larvae apparently removes/reduces the amount of the enzyme in the larvae gut and as a result reduces the darkening rate of puree obtained from the whole larvae. About 150 g each of stimulated and unstimulated BSF larvae were used in 3 replicates (in total 3 × 150 g = 450 g from each group of larvae) in this experiment. The larvae were first washed under running tap water for ~30 seconds, and then the larvae were minced and placed in transparent cups. The minced larvae were kept at room temperature for 2 hours. Then, the color of the two products was visually assessed and results were compared (FIG. 4).

### Microbial Content

About 100 g larvae of Group (1) and of Group (2) in 3 replicates (300 g in total) were used in this experiment. Puree was made using the same method described above. The puree was pasteurized for 2 minutes at 90° C. Immediately after pasteurization the puree samples were transferred into a freezer at -18° C. The frozen samples were sent to Nutrilab for total microbial plate count, for microbial analysis.

### Statistical Analysis

Percentage of degutting (gut evacuation) was calculated based on the assumption that the six gut areas (i.e. FG, AMG, MMG, PMG, AHG and PMG) have the same length and the data was analyzed using a linear regression. Linear regressions were also used to compare the two groups of stimulated and unstimulated larvae when their nutritional composition was considered, when the microbial content of the larvae puree was considered, and when the weight of the BSF larvae was assessed.

### Results

### Gut Evacuation

Gut evacuation was affected by the type of feed (chicken feed versus BSF larvae feed) (df = 1; F = 4.56; P = 0.032) and the temperature (10° C. versus room temperature versus 37° C.) (df = 2; F = 26.01; P < 0.001) and substrate (water versus feed versus fasting (no water, no feed)) (df = 2; F = 19.06; P < 0.001) conditions under which the larvae were kept after harvest. Less than complete gut evacuation (complete gut evacuation defined as > 90% of the gut content expelled from the gut of the BSF larvae, based on the weight of the BSF larvae before the BSF larvae are subjected to stimulation; degutting rate or degutting efficiency) was observed in the larvae that had been kept at 10° C. In the larvae that had been fed with the chicken feed, the most complete gut evacuation was observed after 48 h in the feed as well as under fasting conditions (FIG. 1). In the BSF larvae feed (mixture of grain meal and potato meal in water), the complete gut evacuation was observed in water at room temperature after 6 h and under fasting conditions after 48 h. At all three temperature conditions, the highest level of gut evacuation in the shortest time (1 h) was obtained in water (FIG. 1).

Compared with the unstimulated larvae, stimulated larvae showed lower wet weight (df = 1; F = 18.04; P < 0.001) while they were similar in terms of their dry weights (df = 1; F = 2.39; P = 0.12 (FIG. 2).

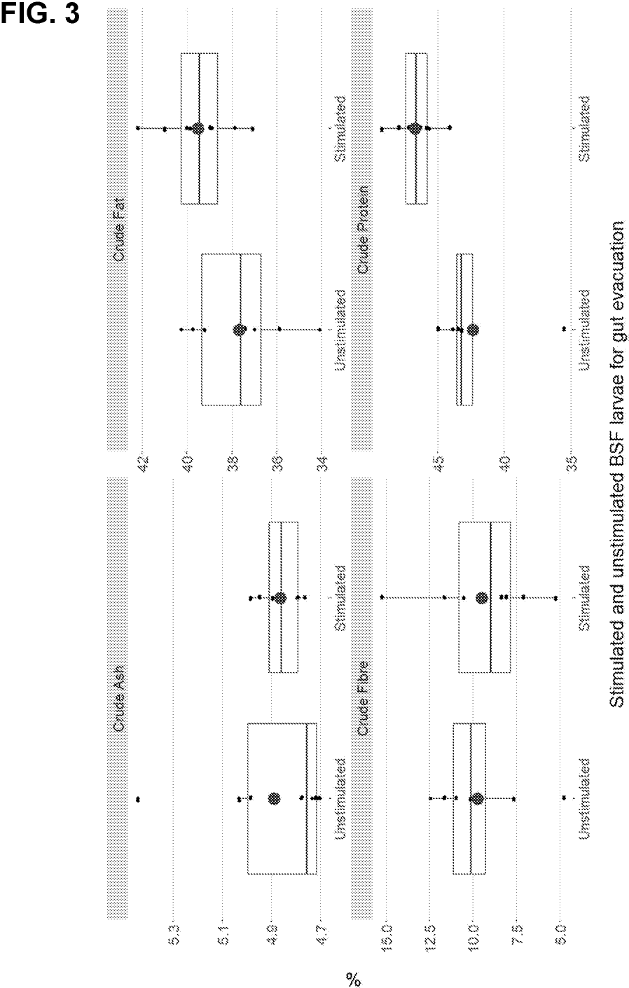

No significant differences were also observed between the stimulated and unstimulated larvae in terms of crude ash (df = 1; F = 0.43; P = 0.54), and crude fiber (df = 1; F = 0.87; P = 0.78), while the stimulated larvae showed higher crude protein content (df = 1; F = 12.44; P = 0.003) and crude fat content (df = 1; F = 3.51; P = 0.08) compared with the unstimulated larvae (FIG. 3).

After 2 h exposure of the BSF minced larvae (i.e. the BSF larvae puree), at room temperature, color of the under-surface area of the puree became dark in the batches of puree obtained by mincing unstimulated larvae (FIG. 4C and FIG. 4D). In contrast, the color of the batches of puree obtained by mincing BSF larvae that were exposed to gut-evacuating conditions (1 h in water at room temperature), did not change in the 2-h period of time (FIG. 4Aand FIG. 4B).

Total microbial plate count of the pasteurized puree of the stimulated larvae (larvae exposed to gut-evacuating conditions (1 h in water at room temperature)) was significantly lower (about 2 million/plate) than the total microbial plate count obtained after culturing of pasteurized puree derived from the unstimulated larvae (about 18, 5 million/plate) (df = 1; F = 37.99; P = 0.003) (FIG. 5; million/plate). The microbial plate count was assessed after 16 h culturing of the plates.

### Summary

The extent of (stimulated) degutting of BSF larvae depends on the type of rearing diet (chicken feed versus BSF larvae feed; BSF larvae feed is preferred) and environmental conditions after harvest (incubation at room temperature is preferred over incubation at 10° C. or at 37° C.); different gut evacuation patterns were observed in the black soldier fly (BSF) larvae. At 10° C., gut evacuation was not completed (>90% was not reached). In the larvae that had been reared on the chicken feed, complete gut evacuation was observed after 48 h under fasting conditions as well as for the larvae kept in feed. When the BSF larvae were fed BSF larvae feed (grain meal/potato meal in water), only larvae incubated at room temperature in water after 6 h and the fasted larvae after incubation at room temperature for 48 h showed complete gut evacuations.

Since the shortening of the pre-slaughter period is important to avoid the decline of nutritional and microbial qualities of larvae, the most suitable approach for improving on time-to-slaughter after larvae harvest and for improving on providing larvae with minimal microbial count possible, is the method of the invention that provides the highest level of gut evacuation in the shortest time (1 h) at room temperature when larvae are kept in water.

The inventors established that with the degutting methods of the invention improvements in the nutritional qualities (fat and protein content), microbial burden, and color quality of the larvae were optimal when larvae were degutted in water (room temperature, at least 1 h). These larvae showed higher crude protein content and higher fat content, lower microbial content, lower wet weight, lighter puree color, and no change in their dry weight, ash, and fiber contents, compared with the larvae that had been kept in the feed and that were unstimulated.

Thus, the degutting method using a water bath after harvest of larvae improves the quality of larvae that are subjected to processing steps such as mincing and providing puree.

### Example 2: Mealworm

### Method

Mealworms were kept on feed. At day 1, mealworms were transferred to a new crate and kept without access to feed (starvation). A different batch of mealworms was kept for two days without access to feed. A third batch of mealworms was kept for three days without access to feed. Extend of gut evacuation was assessed after 1, 2 and 3 days of starvation, compared with control mealworms, that had full access to feed during the course of these days.

Mealworms were dissected to determine the percentage of their gut evacuation over time. The control larvae were harvested daily from the same feed and transferred immediately to a freezer to fix the gut content for dissection, as described here above for Example 1.

To explore the possibility of the stimulation of gut evacuation by water, a group of mealworms was placed in water for 1 hour at room temperature on the first day. These larvae were transferred into the freezer at the same time as the larvae of the first day from the substrate.

### Results

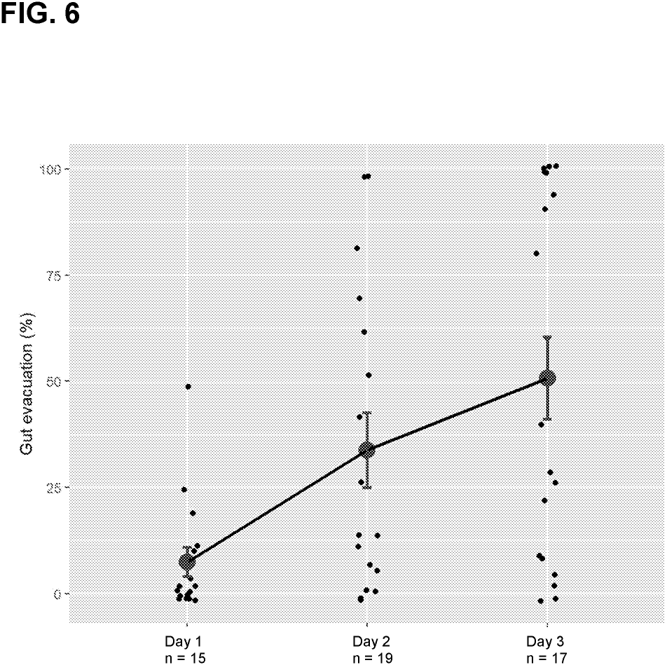

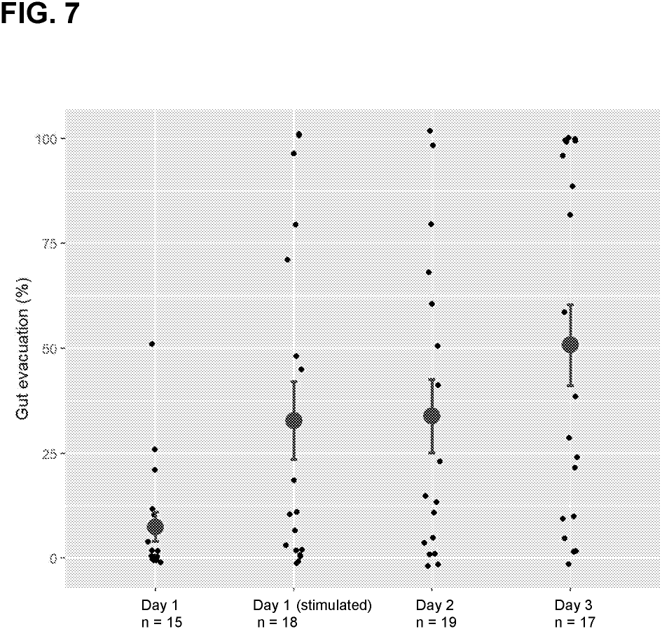

During the course of day 1 to day 2 to day 3 (starvation of mealworms for 1 day, 2 days, 3 days, respectively), gut evacuation of starved mealworm increased compared with mealworms that were kept in feed, from about 10% to about 33% to about 50%, respectively (FIG. 6). By incubating the mealworms for 1 h at room temperature in water, the same extent of degutting of the mealworms was achieved, that was also achieved by starving mealworms for 2 days (FIG. 7). The incubation in water for 1 h at room temperature saves time, when a minimal extent of degutting of at least 30% is desired, i.e. about 23 h. This allows quicker processing after harvesting of the degutted mealworms, saving time, keeping mealworms more fresh, without the need for 2 days starvation, which starvation would result in a decline of nutritional value (less protein, less fat, compared to non-starved mealworms which are degutted in water). The current practice is a 2-days starvation of mealworms, before these mealworms are subjected to processing such as drying. Now, the current inventors show that this 2-days period is reduced to 1 hour, while providing the same results when extent of degutting is considered.

### Summarizing Observations

Referring to the degutting method of example 1 here above, including incubating insects in water, mealworm gut evacuation increases over time when incubated without access to feed. The degutting of the mealworm does not reach completeness (> 90%) when the mealworm is kept without the substrate (feed). Gut evacuation is stimulated and speeded up by placing the mealworms in water. A 1 hour incubation in water resembles two days starvation of the mealworms.

Based on the method of the invention, a degutted mealworm is provided that is typically suitable for any or all of the processing steps commonly applied with mealworms:
1. Rinsing;
2. Killing by freezing (or boiling water);
3. Heat treatment (in boiling water);
4. Freezing;
5. Packaging;
6. Freeze drying.

With the degutted mealworms of the invention, provided with the method of the invention, mealworms are provided that comprise better taste, less microbes and a higher protein and/or fat content, when compared to mealworms that were not subjected to the degutting method of the invention, such that the subsequently rinsed, frozen, boiled, packaged and/or lyophilized degutted mealworms also comprise less microbes and a higher protein and/or fat content, when compared to mealworms that were not subjected to the degutting method of the invention.

### Example 3 - Taste of Degutted Insects Versus Taste of Non-Degutted Insects

### BSF Larvae

Two groups of BSF larvae are provided according to step a. of the method; Group (1) and Group (2). The larvae are about 10-18 days of age post hatching, e.g. about 14 days of age. The larvae in Group (1) are ‘stimulated’, meaning that the larvae are subjected to step b. of the method of the invention for 1 hour in water at room temperature. Larvae in Group (2) are ‘unstimulated’ for degutting, meaning that the insects are not subjected to step b. (and c.) of the method. Insects of Group (1) and (2) are compared in the following experimental settings:

Cat palatability trials
1. Feed production:
   Wet feed is used for cat palatability testing
   Wet feed is bought from the local supermarket (NL).
   Test preparation is produced by blending x% of puree of minced degutted BSF larvae (Group (1)), obtained with the method of the invention, in the above-mentioned wet cat feed. The test preparation is allowed to temper for 1 week after blending.
   Control treatment contains puree from minced non-degutted insects (Group (2)), while test treatment contains puree from minced degutted insects obtained with step b. or c. of the method of the invention (Group (1)).
2. Palatability testing
   Control (comprising puree of non-degutted BSF larvae, Group (2)) and test preparations (comprising puree of minced degutted BSF larvae according to the invention or according to the method of the invention; Group (1)) are offered to cats for palatability testing.
   Design:
      Number of cats: 20, for testing 20 test preparations and 20 control preparations, in parallel side by side for each cat in the trial;
      Duration of testing: 4 days;
      Portion size: 50 g/cat/day of test preparation and 50 g/cat/day of control preparation, for each cat.
   2 portions (1 test preparation and 1 control preparation) is offered to each cat in the morning. The weight of leftover feed will be measured next morning (exactly after 24 h) and recorded. Portion (test preparation Group (1) or control preparation Group (2)) with less leftover is considered more palatable.

### Mealworms

Two groups of mealworms are provided according to step a. of the method; Group (A) and Group (B). The mealworms in Group (A) are ‘stimulated’, meaning that the mealworms are subjected to step b. of the method of the invention for 48 hours in water at room temperature. Mealworms in Group (B) are ‘unstimulated’ for degutting, meaning that the insects are not subjected to step b. (and c.) of the method. The mealworms of Group (A) are freeze-dried after step c. of the method of the invention; mealworms of Group (B) are freeze-dried directly after step a. of the method of the invention. Insects of Group (A) and (B) are compared in the following experimental settings:
1. Sensory test including at least 30 human subjects, wherein the subjects are provided with the freeze-dried mealworms from each Group; and
2. The human subjects rank the taste of the stimulated mealworms and the non-stimulated mealworms at a scale ranging from 1 (very bad) to 5 (very good).

### REFERENCES

Marco Bonelli, Daniele Bruno, Silvia Caccia, Giovanna Sgambetterra, Silvia Cappellozza, Costanza Jucker, Gianluca Tettamanti and Morena Casartelli, “Structural and Functional Characterization of Hermetia illucens Larval Midgut”, Frontiers in Physiology, 8 Mar. 2019, Volume 10, Article 204, doi: 10.3389/fphys.2019.00204

### Example 4 - Time Frame of Degutting of Living BSF Larvae

Keeping BSF larvae 14 days of age post hatching in water (room temperature) for about 20 minutes already gave at least some degutting. The BSF larvae are kept in bulk in a silo filled with water at ambient temperature such as a temperature between 10° C. and 33° C., for 1-3 days, and commonly for about 24 hours, while staying alive and while degutting in this time period in the silo. Keeping the BSF larvae in water for about 24 hr, about 48 hr or about 72 hr at about 10° C. to room temperature or ambient temperature results in degutting, as assessed by visual inspection, and keeps the larvae alive.

1. Method for providing a degutted insect, the method consisting of the steps or the method comprising the steps:
a. providing an insect and providing a liquid at a predetermined temperature;
b. suspending the insect of step a. in the liquid of step a. and incubating the insect in the liquid for a predetermined time at the predetermined temperature or at a temperature range, therewith stimulating degutting of the insect and release of gut content of the insect into the liquid; and
c. at the end of the predetermined time of step b., optionally separating the insect of step b. from the liquid comprising gut content,
therewith providing the degutted insect by step b. or by optional step c. and providing liquid comprising gut content.

2. Method according to claim 1, wherein the insect is larvae of the black soldier fly ( Hermetia illucens), more preferably, black soldier fly larvae 5 to 25 days of age, preferably 10-20 days post-hatching, most preferably black soldier fly larvae at a stage 6 hours - 4 days before prepupation of the larvae, such as 6 hours - 30 hours before prepupation of the larvae, or wherein the insect is mealworm.

3. Method according to claim 1 or 2, wherein the liquid is an aqueous liquid or a liquid comprising water, preferably the liquid is any one of water, tap water, aqueous physiological salt solution at pH 5.5 - 8.5, aqueous physiological NaCl solution at pH 5.5 - 8.5, preferably pH 6.5 - 7.5, and an aqueous citric acid solution at pH 5.0 - 7.5, more preferably the liquid is water or tap water, most preferably, the pH is 6.5 - 7.5, and/or the liquid is water.

4. Method according to any one of the claims 1-3, wherein the predetermined temperature in step b. is above 12° C. and below 37° C., preferably 15° C. - 33° C., more preferably 18° C. - 30° C., most preferably 20° C. - 28° C., such as 21° C. - 27° C. or 22° C. or 26° C., or wherein the temperature range in step b. is a range between from minimally 12° C. at the start of the incubation of step b. and maximally 37° C. at the end of said incubation or is a range between from maximally 37° C. at the start of the incubation of step b. and above 12° C. at the end of said incubation, preferably the temperature range is from 15° C. to 33° C. or from 33° C. to 15° C., more preferably from 18° C. to 30° C. or from 30° C. to 18° C., most preferably from 20° C. to 28° C. or from 28° C. to 20° C., such as from 21° C. to 27° C. or from 27° C. to 21° C.

5. Method according to any one of the claims 1-4, wherein in step b. the predetermined time is between 5 minutes and 96 hours, preferably 10 minutes-48 hours, more preferably 20 minutes - 24 hours, most preferably 30 minutes - 12 hours, such as 45 minutes, 1 hour, 1.5 hour.

6. Method according to any one of the claims 1-5, wherein in step b. and in optional step c. the provided degutted insect is a live degutted insect, preferably a live black soldier fly larva or a live mealworm, or wherein in step b. or in optional step c. the provided degutted insect is a dead degutted insect, preferably a dead black soldier fly larva or a dead mealworm.

7. Method according to any one of the claims 1-6, wherein in step a. the provided insect is an insect that was fed up till 0 minutes - 12 hours before the insect is being subjected to step b. of the method, preferably 0 minutes - 6 hours, more preferably 0 minutes - 3 hours, most preferably 0 minutes 2 hours, such as fed up to 0 minutes before the insect is being subjected to step b. of the method, or 10 minutes, 20 minutes, 30 minutes, 45 minutes or 1 hour before the insect is being subjected to step b. of the method.

8. Method according to any one of the claims 1-7, wherein in step b. 1% by weight - 25% by weight gut content of the insect is excreted from the insect into the liquid, based on the total weight of the insect provided in step a., preferably 2% - 22%, more preferably 3% - 17%, most preferably 4% - 14%, such as 5%, 7%, 10%, 12%, 20%.

9. Method according to any one of the claims 1-8, wherein in step b. or in optional step c. 0, 5% by weight - 30% by weight of the degutted insect consists of the liquid provided in step a., based on the total weight of the insect provided in step a., preferably 1% - 22%, more preferably 2% -19%, most preferably 3% - 17%, such as 4%, 7%, 10%, 14%, 23%.

10. Method according to any one of the claims 1-9, wherein in step b. or in optional step c. the total microbial count of the degutted insect is lower than the total microbial count of the insect provided in step a. of the method, preferably at least two times lower, preferably at least 4 times lower, more preferably at least 6 times lower, most preferably at least 10 times lower, such as 2 - 50 times lower, 4 - 30 times lower, 6 - 25 times lower, or 9 times lower, 15 times lower, 18 times lower, 25 times lower, said total microbial count, for example, established as the total microbial count on a plate after 16 h culturing.

11. Method according to any one of the claims 1-10, wherein in step b. or in optional step c. the B.cereus count and/or the E.coli count of the degutted insect is lower than said count(s) for the insect provided in step a. of the method, preferably at least two times lower, preferably at least 4 times lower, more preferably at least 6 times lower, most preferably at least 10 times lower, such as 2 - 50 times lower, 4 - 30 times lower, 6 - 25 times lower, or 9 times lower, 15 times lower, 18 times lower, 25 times lower, said count(s) in cfu/g per gram degutted insect provided with step b. or provided with optional step c. and in cfu/g per gram insect provided in step a., respectively.

12. Method according to any one of the claims 1-11, wherein in step a. the insect is black soldier fly larvae 12 - 24 days of age post hatching, preferably 6 hours - 2 days before prepupation of the larvae, and/or in step a. the provided insect is an insect that was fed up till 0 minutes - 1.5 hours before the insect is being subjected to step b. of the method, and/or the liquid is water or tap water, and/or the predetermined temperature of the liquid in step a. and step b. is 18° C. - 28° C., preferably 21° C. - 27° C., and/or the predetermined time in step b. is 30 minutes - 1.5 hours, preferably 50 minutes - 80 minutes, and/or wherein in step b. or in optional step c. the provided degutted insect is a living degutted insect, preferably, in step a. the insect is black soldier fly larvae 18 - 24 days of age post hatching and 6 hours - 30 hours before prepupation of the larvae, and in step a. the provided insect is an insect that was fed up till 0 minutes - 1 hour before the insect is being subjected to step b. of the method, and the liquid is water or tap water, and the predetermined temperature of the liquid in step a. and step b. is 19° C. - 27° C., and the predetermined time in step b. is 45 minutes - 75 minutes, and in step b. or in optional step c. the provided degutted insect is a living degutted insect.

13. Method according to any one of the claims 1-12, wherein the insect is black soldier fly larvae that were fed a feed consisting of a mixture of grain meal, potato meal and water, before being subjected to step a. of the method.

14. Method according to any one of the claims 1-13, wherein the absolute weight amount of lipid and fat of the degutted insect provided with step b. or with optional step c. of the method is at least 80% of the absolute weight amount of lipid and fat of the insect provided in step a. of the method, preferably at least 85%, more preferably at least 90%, most preferably at least 95%, such as at least 97%, at least 98%, at least 99%, at least 99.5%, such as 100% - 125%, and/or wherein the absolute weight amount of protein of the degutted insect provided with step b. or with optional step c. of the method is at least 80% of the absolute weight amount of protein of the insect provided in step a. of the method, preferably at least 85%, more preferably at least 90%, most preferably at least 95%, such as at least 97%, at least 98%, at least 99%, at least 99.5%, such as 100% - 125%.

15. Method according to any one of the claims 1, wherein at the end of step b. of the method at least 25% by weight gut content of the insect is excreted from the insect into the liquid, based on the total weight of the gut content in the insect provided in step a., preferably at least 40%, more preferably at least 60%, most preferably at least 70%, such as 25% - 90% or 25% - 100%.

16. Method according to any one of the claims 1-7, 10-15, wherein at the end of step b. of the method or in optional step c. at least 30% by weight of the gut content in the degutted insect consists of the liquid provided in step a., based on the total weight of the gut content in the insect provided in step a., preferably at least 40%, more preferably at least 50%, most preferably at least 60%, such as 30%-95% or 30%-100%.

17. Method according to any one of the claims 1-16, wherein in step b. the predetermined time is between 5 minutes and 10 hours, preferably 10 minutes - 6 hours, more preferably 20 minutes - 3 hours, most preferably 30 minutes - 2 hours, such as 40 minutes, 50 minutes, 1 hour, 30 minutes - 90 minutes.

18. Degutted insect wherein the gut of the insect is at least partly filled with liquid, wherein preferably the degutted insect is a live black soldier fly larva, preferably 10-14 days of age post hatching, wherein the liquid preferably is water such as tap water, and wherein preferably the degutted insect has taken in feed up to a time point 30 minutes - 3 hours in the past.

19. Degutted insect according to claim 18, wherein the insect is larvae of the black soldier fly (Hermetia illucens), or wherein the insect is mealworm, and/or the liquid is water or tap water, and/or wherein the liquid in the gut of the insect amounts to at least 5% by weight based on the total weight of the insect, preferably 5% - 25%, more preferably 8% - 22%, and/or wherein the degutted insect is a living insect, preferably the insect are living black soldier fly larvae and preferably the liquid is water or tap water.

20. Degutted insect according to claim 18 or 19, wherein the degutted insect is obtained with the method of any one of the claims 1-17, or wherein the degutted insect is obtainable by the method of any one of the claims 1-17.

21. Degutted insect according to any one of the claims 18-20, wherein the degutted insect is a live insect such as a live BSF larva or a live mealworm, or wherein the degutted insect is a dead insect such as a dead BSF larva or a dead mealworm.

22. Use of the degutted insect according to any one of the claims 18-21 for the provision of processed degutted insect, the processing comprising, for example, any one or more of mincing, cutting, particulating, grinding, pressing, crunching, drying, heating, blanching, lyophilizing, fractioning, hydrolyzing degutted insect, and any combination thereof.

23. Use of the degutted insect according to any one of the claims 18-21 or use of the processed degutted insect of claim 21 for the separation of the degutted insect or of the processed degutted insect in at least a fat fraction and/or at least a protein fraction, preferably in both a fat fraction and a protein fraction, wherein preferably the fat fraction comprises at least 35% by weight insect fat based on the total dry weight of the degutted insect or the processed degutted insect, more preferably at least 38%, such as 38% - 42%, and/or wherein preferably the protein fraction comprises at least 40% by weight insect protein based on the total dry weight of the degutted insect or the processed degutted insect, more preferably at least 45%, such as 44% - 50%.

24. Insect product, wherein the insect product is insect puree obtained from degutted insect, wherein the degutted insect is preferably provided with the method of any one of the claims 1-17 or obtained from the degutted insect of any one of the claims 18-21 or obtained from the processed degutted insect of claim 22.

25. Insect product, wherein the insect product is insect powder, particulate insect, granulated insect, ground insect, or insect meal, obtained from degutted insect, wherein the degutted insect is preferably provided with the method of any one of the claims 1-17 or obtained from the degutted insect of any one of the claims 18-21 or obtained from the processed degutted insect of claim 22.

26. Insect product, wherein the insect product is dried insect, oven-dried insect, lyophilized insect, or oven-dried insect using refractive drying, obtained from degutted insect, wherein the degutted insect is preferably provided with the method of any one of the claims 1-17 or obtained from the degutted insect of any one of the claims 18-21 or obtained from the processed degutted insect of claim 22.

27. Insect product, wherein the insect product is insect gut content, wherein the gut content is preferably provided with the method of any one of the claims 1-17.

28. Insect product according to any one of the claims 24-27, wherein the insect is black soldier fly larvae, or wherein the insect is mealworm.

29. Use of the degutted insect according to claim 23, wherein the insect is black soldier fly larvae, or wherein the insect is mealworm.
